(19) United States
(12) Patent Application Publication
(10) Pub. No.: US 2016/0329751 A1
(43) Pub. Date: Nov. 10, 2016

(54) WIRELESS POWER TRANSMISSION SYSTEM AND METHOD CONTROLLED VIA DIGITAL MESSAGES

(71) Applicant: POWERMAT TECHNOLOGIES LTD., Neve IIan (IL)

(72) Inventors: Elieser Mach, Rosh Tzurim (IL); Oz Moshkovich, Rehovot (IL); Yuval Koren, Rehovot (IL); Guy Raveh, Mataa (IL); Itay Sherman, Hod Hasharon (IL); Oola Greenwald, Mevasseret Zion (IL); Arik Rofe, Bet Hakerem (IL); Ian Podkamien, Petach Tikva (IL)

(21) Appl. No.: 15/103,198

(22) PCT Filed: Dec. 10, 2014
(86) PCT No.: PCT/IL2014/051081

§ 371 Date: Jun. 9, 2016

Related U.S. Application Data
(60) Provisional application No. 61/950,559, filed on Mar. 10, 2014.
(60) Provisional application No. 61/914,406, filed on Dec. 11, 2013.

(51) Int. Cl. H02J 50/12; H02J 7/02; H02J 50/90; H02J 50/80; H02J 50/20

(52) U.S. Cl. CPC H02J 50/12; H02J 50/80; H02J 50/20; H02J 50/90; H02J 7/025

(57) ABSTRACT

The disclosure relates to systems and methods for controlling a wireless power transfer system based upon Inductive Charging Technology using frequency based signaling communication protocol, operable to function in modes of Standby, Digital Ping, Identification, Power Transfer and End of Charge (EOC). The power transfer system comprising at least one wireless power outlet associated with a wireless power transmitter coil and at least one electrical device associated with a wireless power receiver coil, where the wireless power receiver coil is in multi-directional communication with the wireless power transmission of a message transmitter coil. The amount of power transferred is controlled by feedback communication between the receiver and the transmitter configured to increase or NO decrease power. More specifically, the present disclosure supports wireless power transfer incorporating transmission opportunity extended signaling supporting uni-directional and bi-directional communication enabling data transfer over extended range, higher power levels of power transfer and improved foreign object detection functionality.

### FIELD OF THE INVENTION

The present invention is directed to providing energy efficient inductive power transfer. More specifically, the present invention relates to wireless power transfer systems and methods incorporating extended signaling supporting multi-directional communication to enable data transfer over extended range, higher power levels and improved foreign object detection functionality.

### BACKGROUND OF THE INVENTION

The efficient use of available energy is of great importance for a number of reasons. On a global scale, there is increasing concern that the emission of greenhouse gases such as carbon dioxide from the burning of fossil fuels may precipitate global warming. Moreover, energy resources are limited. The scarcity of global energy resources alongside geopolitical factors drives the cost of energy upwards. Thus efficient use of energy is an ever more important budget consideration for the energy consumer.

Energy losses in electrical energy transmission are chiefly due to the incidental heating of current carrying wires. In many cases this is unavoidable, as current carrying wires are essential for the powering of electrical devices and current carrying wires have resistance. It is the work done to overcome this resistance which generates heat in the wires.

In other cases the energy losses are unnecessary. For example, electrical devices are often left running unnecessarily and energy used to power devices which are not being used is truly wasted. Various initiatives aimed at reducing the amount of energy wasted by idle devices have been proposed. For example, Energy Star is a joint program of the United States Environmental Protection Agency and the United States Department of Energy which awards manufacturers the right to display a recognizable label on products which meet certain energy consumption standards. Energy Star attempts to reduce energy consumption through better energy management.

Efficient energy management reduces energy wastage. For example, laptop computers, which rely upon a limited amount of energy supplied from onboard power cells, use a variety of strategies for keeping power consumption to a minimum. Thus the screen and hard drives are switched off automatically after the computer has been left inactive for a significant length of time, similarly the network card may be disabled when the computer is disconnected from the mains or from a network. Such energy management strategies may serve to increase the length of time that a device can be powered by its onboard cells.

Even when connected to the mains, however, efficient use of energy is essential. Many common electrical devices run on low voltage DC and typically use a transformer with an AC-DC power adapter to control the power provided to it. Energy Star estimates that 1.5 billion such power adapters are used in the United States alone for devices such as MP3 players, Personal Digital Assistants (PDAs), camcorders, digital cameras, emergency lights, cordless and mobile phones. According to Energy Star, such power adapters draw about 300 billion kilowatt-hours of energy every year which is approximately 11% of the United States' national electric bill.

If multiple devices could be run from a single power adapter this would greatly reduce the number of power adapters in use. However, the supply of electricity to a number of devices through a single cable is not trivial. The more devices that are connected to a single power strip the greater the current which is drawn by the strip. Thus the current supplied through the single cable connecting the power strip to the mains increases.

Power losses due to the heating of a cable increase according to the square of the current it carries so energy losses from the cable may increase parabolically. Furthermore, in the absence of effective energy management, if too many devices draw current from a single cable the current supplied may exceed the permitted level thereby tripping a circuit breaker or blowing a fuse. Even more seriously, the excessive current may lead to overheating of the cable which is a common cause of fire.

A further unnecessary usage of energy is in powering of devices having onboard power cells. When an electric device having rechargeable cells such as a laptop computer, electric shaver or the like, is connected to the mains power is drawn both to operate the device and also to recharge the cells. Although electrical cells do need to be recharged periodically, even partially charged cells are sufficient to power the device. It is unnecessary therefore to continuously charge the onboard cell.

Furthermore, the energy needlessly consumed charging electrical cells beyond the level necessary for operation of a device increases electricity bills. This is of particular concern where a large number of such devices are being used simultaneously. For example for a company which hosts a meeting or a conference where many individual laptop computers are being used simultaneously.

Inductive power coupling allows energy to be transferred from a power supply to an electric load without a wired connection therebetween. An oscillating electric potential is applied across a primary inductor. This sets up an oscillating magnetic field in the vicinity of the primary inductor. The oscillating magnetic field may induce a secondary oscillating electrical potential in a secondary inductor placed close to the primary inductor. In this way, electrical energy may be transmitted from the primary inductor to the secondary inductor by electromagnetic induction without a conductive connection between the inductors.

When electrical energy is transferred from a primary inductor to a secondary inductor, the inductors are said to be inductively coupled. An electric load wired in series with such a secondary inductor may draw energy from the power source wired to the primary inductor when the secondary inductor is inductively coupled thereto.

The strength of the induced voltage in the secondary inductor varies according to the oscillating frequency of the electrical potential provided to the primary inductor. The induced voltage is strongest when the oscillating frequency equals the resonant frequency of the system. The resonant frequency f_{R} depends upon various factors, such as the inductance L and the capacitance C of the system according to the equation

$${f}_{R} \approx \frac{1}{2 π \sqrt{LC}} .$$

Known inductive power transfer systems typically transmit power at the resonant frequency of the inductive couple. This can be difficult to maintain as the resonant frequency of the system may fluctuate during power transmission, for example in response to changing environmental conditions or variations in alignment between primary and secondary coils.

Amongst others, one problem associated with resonant transmission is the high transmission voltages involved. At high operating voltages, a large amount of heat may be generated by the system resulting in high power losses as well as damage to heat sensitive components. Accordingly, capacitors and transistors in the resonant circuits may need to be relatively large.

The need remains therefore for an energy efficient inductive power transfer system which may incur lower power losses during operation. The current disclosure addresses this need.

### SUMMARY OF THE INVENTION

According to various embodiments an inductive power receiver is introduced which is configured to draw power from an inductive power outlet or transmitter. The inductive power receiver includes: a resonant circuit comprising a secondary coil configured to inductively couple with a primary coil of the inductive power outlet, the resonant circuit having a characteristic resonant peak at a frequency lower than an operational frequency of the inductive power outlet such that operating at a higher frequency reduces the amount of power transferred; a rectifier; a rectified current sense; a communication and control unit operable to communicate power control instructions to an inductive power outlet comprising: at least one communications modulator operable to create at least a first state and a second state such that transitioning from the first state to the second state produces a detectable change at the primary coil; and at least one signal generator operable to generate communication signals comprising a series of pulses generated at a characteristic frequency f, each the pulse comprising a fixed duration tₛ of high logical state followed by a second duration (1/f−tₛ) of low logical state, and wherein the communication and control unit is operable to select a communication signal from at least one of a set of communication signals comprising: a P-DOWN signal having a characteristic frequency of 1 kHz, a P-UP signal having a characteristic frequency of 8 kHz, a P-SAME signal having a characteristic frequency of 500 Hz, an END-SIG signal having a characteristic frequency of 250 Hz, a MsgBIT signal having a characteristic frequency of 6 kHz, and optionally a SPARE signal having a characteristic frequency of 4 kHz. Optionally, the characteristic resonant frequency is less than 115 kilohertz.

Variously, the inductive power receiver may further comprise a temperature regulation module, an alignment mechanism, a detection mechanism configured to trigger the inductive power outlet. Optionally, the detection mechanism comprises at least one magnetic material detectable by a Hall Effect sensor. Optionally, again, the detection mechanism comprises at least one magnetic material selected such that when the inductive power receiver is placed adjacent to a surface, a 40 Gauss difference in magnetic field is detectable by a Hall Effect sensor situated 2 millimeters behind the surface and within a radius of 4 millimeters.

Additionally or alternatively, active detection mechanism may be applicable allowing better detection functionality of inductive power receivers.

Variously, the detection mechanism is operable to respond to a digital ping by transmitting a P-DOWN signal having a characteristic frequency of 1 kHz. Additionally or alternatively, the detection mechanism is operable to respond to a digital ping by transmitting an END-SIG signal if an end-of-charge condition is detected.

Optionally, the communications modulator is selected from at least one of an ancillary resistor and an ancillary capacitor.

According to one aspect of the disclosure an inductive power outlet is presented for transmitting power to at least one inductive power receiver. The inductive power outlet comprises at least one primary inductor wired to a power supply, the primary inductor for forming an inductive couple with at least one secondary inductive coil associated with the inductive power receiver; and at least one driver configured to provide an oscillating voltage across the primary inductor.

The inductive power receiver may comprise the at least one secondary inductive coil; and an output regulator operable to monitor induced voltage across the secondary inductive coil; to detect an activation voltage pulse; to compare the induced voltage with at least one threshold value; to send at least one instruction signal to the inductive power outlet; and to provide power to an electric load.

It is noted that detecting frequency modulation and/or other modulations, may be initiated by the transmitter.

It is further noted that the demodulation unit of the inductive power receiver is the base for the bi-directional communication.

The inductive power outlet may be operable to induce an activation voltage pulse across the secondary inductive coil of the inductive power receiver thereby initiating the inductive power receiver to send an identification signal to the inductive power outlet and to start drawing power therefrom.

Optionally, the inductive power receiver further comprises a signal transmission circuit operable to generate the at least one instruction signal. The transmission circuit may comprise at least one ancillary load selectively connectable to the secondary inductor by a switching unit, wherein the switching unit is configured to connect the ancillary load to the secondary inductor with a characteristic frequency thereby producing a pulse of detectable peaks in primary voltage or primary current having the characteristic frequency. It is noted that the instruction signal can be “in band” and/or “out of band” or a combination where the in-band communication is used to establish another out of band, means of communication.

Optionally, the at least one instruction signal comprising a pulse may have a characteristic frequency of peaks in primary voltage or primary current, wherein the inductive power outlet further comprises: at least one peak detector configured to detect the peaks; and at least one processor operable to determine the characteristic frequency of the peaks.
In other embodiments, the outlet further comprises a signal detector operable to detect the instruction signals and the driver is operable to perform at least one function selected from a group consisting of:
selecting a first operating power if the signal detector detects a first instruction signal;
selecting a second operating power if the signal detector detects a second instruction signal;
increasing operating power by a first increment if the signal detector detects a third instruction signal;
increasing operating power by a second increment if the signal detector detects a fourth instruction signal;
decreasing operating power by a first increment if the signal detector detects a fifth instruction signal;
decreasing operating power by a second increment if the signal detector detects a sixth instruction signal;
continuing to provide the oscillating voltage across the primary inductor at same power if the signal detector detects a seventh instruction signal; and
ceasing to provide the oscillating voltage across the primary inductor if the signal detector detects an eighth instruction signal.

The inductive power outlet may further comprise a trigger sensor configured to detect a release signal indicating proximity of a possible inductive power receiver.

Optionally, the activation voltage pulse comprises an induced voltage across the secondary inductive coil of at least eight volts. Where appropriate, the activation voltage pulse produces a current of at least three milliamps.

According to a further aspect of the disclosure an inductive power receiver is presented for receiving power from at least one inductive power outlet. The inductive power receiver may comprise at least one secondary inductor for forming an inductive couple with at least one primary inductive coil; and at least one signal transmission circuit configured to generate at least one instruction signal, the instruction signal being detectable by a signal detector associated with the inductive power outlet as a pulse having a characteristic frequency of peaks in primary voltage or primary current. Where required, the inductive power outlet may be configured to drive an oscillating voltage across the primary inductive coil for a limited time duration and to stop driving the oscillating voltage if no instruction signal is received during the time duration; and the transmission circuit may be operable to send at least one instruction signal to the inductive power outlet during each the time duration.

Optionally, the time duration is between five milliseconds and ten milliseconds.

In some embodiments, the transmission by the power receiver of the at least one instruction signal comprises a termination signal and the inductive power outlet is operable to cease driving the primary inductive coil when the termination signal is detected.

Where appropriate, the transmission circuit may comprise a signal generator operable to generate at least one instruction signal having a characteristic frequency selected from at least one of a group consisting of: 250 hertz, 500 hertz, 1 kilohertz, from 1.5 kilohertz to 5 kilohertz and 8 kilohertz.

Optionally, the inductive power receiver further comprises an output regulator operable to monitor induced voltage across the secondary inductor; to compare the induced voltage with at least one threshold value; and to provide power to an electric load. The output regulator may be further operable to generate at least one instruction signal selected from a group consisting of:
an initial pulse of approximately one kilohertz to instruct the inductive power outlet to drive the primary inductive coil at a first operating power;
an initial pulse of approximately 8 kilohertz to instruct the inductive power outlet to drive the primary inductive coil at a second operating power;
a pulse of approximately one kilohertz to instruct the inductive power outlet to decrease operating power by a first increment;
a pulse of between approximately 1.5 kilohertz and approximately 5 kilohertz to instruct the inductive power outlet to increase operating power by a second increment;
a pulse of approximately 8 kilohertz to instruct the inductive power outlet to increase operating power by a first increment;
a pulse of approximately 500 hertz to instruct the inductive power outlet to continue driving the primary inductive coil at the same power; and
a pulse of approximately 250 hertz to instruct the inductive power outlet to cease driving the primary inductive coil.

In another aspect of the disclosure, a method is taught for transferring power inductively comprising: obtaining an inductive power outlet comprising: at least one primary inductor, at least one driver and at least one instruction signal detector; obtaining an inductive power receiver comprising: at least one secondary inductor and at least one instruction signal generator; driving the primary inductor for a limited time duration; monitoring the signal detector; if at least one instruction signal is detected by the instruction signal detector during the time duration, then repeating steps of driving the primary inductor and monitoring the signal detector; and if no instruction signal is received during the time duration, then terminating the driver. Optionally, the time duration is between five milliseconds and ten milliseconds.

Variously, the method may further comprise at least one of:
if the instruction signal detector detects a termination signal, then terminating the driver;
if the instruction signal detector detects a perpetuation signal, then continuing to drive the primary inductor with the same power;
if the instruction signal detector detects a first increase power signal, then increasing power by a first incremental value;
if the instruction signal detector detects a second increase power signal, then increasing power by a second incremental value; and
if the if the instruction signal detector detects a decrease power signal, then decreasing power by an incremental value.

Where appropriate, the instruction signal generator comprises a signal transmission circuit operable to draw additional power from the secondary inductive coil thereby generating detectable peaks in primary voltage or primary current. Optionally, the instruction signal detector comprises at least one peak detector configured to detect peaks in primary voltage or primary current; and at least one processor operable to determine the characteristic frequency of the peaks;

Additionally or alternatively, the method may further comprise at least one of:
if the peak detector initially detects peaks in primary voltage or primary current having a first characteristic frequency then the driver operating at a first operating power;
if the peak detector initially detects peaks in primary voltage or primary current having a second characteristic frequency then the driver operating at a second operating power;
if the peak detector detects peaks in primary voltage or primary current having a third characteristic frequency then the driver increasing operating power by a first increment;
if the peak detector detects peaks in primary voltage or primary current having a fourth characteristic frequency then the driver increasing operating power by a second increment;
if the peak detector detects peaks in primary voltage or primary current having a fifth characteristic frequency then the driver decreasing operating power by a first increment;
if the peak detector detects peaks in primary voltage or primary current having a sixth characteristic frequency then the driver decreasing operating power by a second increment;
if the peak detector detects peaks in primary voltage or primary current having a seventh characteristic frequency then the driver continuing to operate at same power; and
if the peak detector detects peaks in primary voltage or primary current having an eighth characteristic frequency then the driver ceasing to provide the oscillating voltage.

Variously, the characteristic frequency may be selected from at least one of a group consisting of: 250 hertz, 500 hertz, 1 kilohertz, from 1.5 kilohertz to 5 kilohertz, 6 kilohertz, 8 kilohertz or the like.

Other embodiments of the present invention are directed towards providing an inductive power transfer system comprising at least one inductive power outlet comprising at least one primary inductive coil wired to a power supply via a driver; the primary inductive coil for forming an inductive couple with at least one secondary inductive coil wired to an electric load, the secondary inductive coil associated with an inductive power receiver wherein the driver is configured to provide a driving voltage across the primary inductive coil, the driving voltage oscillating at a transmission frequency significantly different from the resonant frequency of the inductive couple. Optionally, the driver comprises a switching unit for intermittently connecting the primary inductive coil to the power supply.

Optionally, the transmission frequency lies within a range in which induced voltage varies approximately linearly with frequency. Optionally, the driver is configured to adjust the transmission frequency in response to the feedback signals.

Optionally, the inductive power outlet comprising a signal detector adapted to detect a first signal and a second signal, and the driver is configured to: increase the transmission frequency when the first signal is detected by the detector, and decrease the transmission frequency when the second signal is detected by the detector. The feedback signals generally carry data pertaining to the operational parameters of the electric load. Operational parameters are selected from the group comprising: required operating voltage for the electric load; required operating current for the electric load; required operating temperature for the electric load; required operating power for the electric load; measured operating voltage for the electric load; measured operating current for the electric load; measured operating temperature for the electric load; measured operating power for the electric load; power delivered to the primary inductive coil; power received by the secondary inductive coil, and a user identification code. Optionally, the detector is selected from the list comprising optical detectors, radio receivers, audio detectors and voltage peak detectors.

Optionally, the driver further comprises a voltage monitor for monitoring the amplitude of a primary voltage across the primary coil. Optionally, the voltage monitor is configured to detect significant increases in primary voltage.

In other embodiments, the driving voltage oscillating at a transmission frequency higher than the resonant frequency of the inductive couple, wherein the primary inductive coil is further wired to a reception circuit comprising a voltage monitor for monitoring the amplitude of a primary voltage across the primary coil, and the secondary inductive coil is further wired to a transmission circuit for connecting at least one electric element to the secondary inductive coil thereby increasing the resonant frequency, or adjusting the quality factor, allowing the power receiver to handle the power by itself, such that a control signal may be transferred from the transmission circuit of the power receiver to the reception circuit. Optionally, the secondary inductive coil is wired to two inputs of a bridge rectifier and the electric load is wired to two outputs of the bridge rectifier wherein the transmission circuit is wired to one input of the bridge rectifier and one output of the bridge rectifier. Typically, the transmission circuit of the power receiver further comprises a modulator for modulating a bit-rate signal with an input signal to create a modulated signal and a switch for intermittently connecting the electrical element to the secondary inductive coil according to the modulated signal. Optionally, the voltage monitor further comprises a correlator for cross-correlating the amplitude of the primary voltage with the bit-rate signal for producing an output signal.

In certain embodiments, the control signal is for transferring a feedback signal from the secondary inductive coil to the primary inductive coil for regulating power transfer across an inductive power coupling. The driver may be configured to adjust the transmission frequency in response to the feedback signals. Typically, the system is adapted to transfer a first signal and a second signal, and the driver is configured to: increase the transmission frequency when the first signal is received by the receiver, and decrease the transmission frequency when the second signal is received by the receiver.

Variously, embodiments of the invention may be incorporated into at least one application selected from a group consisting of: inductive chargers, inductive power adaptors, power tools, kitchen appliances, bathroom appliances, computers, media players, office equipment, implanted devices, pace makers, trackers and RFID tags inductive chargers, inductive power adaptors

It is a further aim of the current invention to teach a method for regulating power transmission inductive from a primary inductive coil, wired to a power supply via a driver, to a secondary inductive coil, wired to an electric load, the method comprising the following steps: (a)—providing an oscillating voltage to the primary inductive coil at an initial transmission frequency ft which is substantially different from the resonant frequency f_{R} of the system; (b)—inducing a secondary voltage in the secondary inductive coil; (c)—monitoring power received by the electric load; (d)—sending a feedback signal when the monitored power deviates from a predetermined range; (e)—the driver receiving the feedback signal; (f)—the driver adjusting the transmission frequency; and (g)—repeating steps (b)-(f).

Optionally, step (d) further comprises: (d1) sending a feedback signal of a first type Sₐ to the driver, whenever the power drops below a predetermined lower threshold, and (d2) sending a feedback signal of a second type S_{b} to the driver, whenever the power exceeds a predetermined upper threshold.

According to preferred embodiments the initial transmission frequency fₜ is higher than the resonant frequency f_{R} and step (f) further comprises: (f1) the driver reducing the transmission frequency by an incremental value−δf₁ when the received feedback signal is of the first type Sₐ, and (f2) the driver increasing the transmission frequency by an incremental value+δf₂ when the received feedback signal is of the second type S_{b}.

In still other embodiments, the invention is directed to teaching another method for transferring a signal from a secondary inductive coil to a primary inductive coil of an inductive power transfer system, said method comprising the following steps: Step (i)—connecting the primary inductive coil to a voltage monitor for monitoring the amplitude of a primary voltage across the primary coil; Step (ii)—connecting the secondary inductive coil to a transmission circuit for selectively increasing the resonant frequency of the inductive power transfer system; Step (iii)—providing an oscillating voltage to the primary inductive coil at an initial transmission frequency higher or close to the resonant frequency thereby inducing a voltage in the secondary inductive coil; Step (iv)—using the transmission circuit to modulate a bit-rate signal with the input signal to create a modulated signal and connecting the electrical element to the secondary inductive coil intermittently according to the modulated signal, and Step (v)—using the voltage monitor to cross-correlate the amplitude of the primary voltage with the bit-rate signal for producing an output signal.

It is noted that the term ‘resonant frequency’ or ‘effective resonant frequency’ as used herein refers to the frequency of the peak value of a plot of a variable against frequency. It is particularly noted that the resonant frequency effectively increases as a resonant system is damped.

It is noted that in order to implement the methods or systems of the disclosure, various tasks may be performed or completed manually, automatically, or combinations thereof. Moreover, according to selected instrumentation and equipment of particular embodiments of the methods or systems of the disclosure, some tasks may be implemented by hardware, software, firmware or combinations thereof using an operating system. For example, hardware may be implemented as a chip or a circuit such as an ASIC, integrated circuit or the like. As software, selected tasks according to embodiments of the disclosure may be implemented as a plurality of software instructions being executed by a computing device using any suitable operating system.

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data. Optionally, a network connection may additionally or alternatively be provided. User interface devices may be provided such as visual displays, audio output devices, tactile outputs and the like. Furthermore, as required, user input devices may be provided such as keyboards, cameras, microphones, accelerometers, motion detectors or pointing devices such as mice, roller balls, touch pads, touch sensitive screens or the like.

Another aspect of the disclosure is to teach a method for controlling a wireless power transfer system, said wireless power transfer system comprising: at least one wireless power outlet associated with a wireless power transmitter coil and at least one electrical device associated with a wireless power receiver coil, where the wireless power receiver coil is in multi-directional communication with the wireless power transmitter coil, the method comprising the steps of: initiating a data message buffering;—sending at least one message communication to the wireless power transmitter coil; receiving at least one response communication from the wireless power transmitter coil; and executing instructions encoded in control signals included in the least one message communication.

Where appropriate, the step of sending at least one message communication further comprising the steps of: sending a sequence of message initiation signals to the wireless power transmitter coil; buffering at least one data message in the data message buffering; and sending the at least one data message to the wireless power transmitter coil.

Where appropriate, the step of receiving at least one response communication further comprising the steps of: requesting an acknowledge response from the at least one power transmitter coil, operable by sending a TACK_Poll request; receiving at least one data response from the wireless power transmitter coil; decoding the at least one data response; retransmitting the data message buffering, if the decoded at least one data response is erroneous; and clearing the data message buffer structure.

It is noted that during the initial phase of handshake between the power receiver and the power transmitter, the power transmitter may send a message to the power receiver, by modulating operational frequency, even without any specific request from the power receiver side.

Where appropriate, the step of sending at least one data message further comprising the steps of: buffering a byte signal of the at least one data message; sending said byte signal of the at least one data message; and repeating steps of buffering and sending until reaching end of the at least one data message.

Where appropriate, the step of sending at least one data message comprises sending an RXID message.

Optionally, the RXID message comprises data pertaining to a message preamble, a message ID, an identification string and a cyclic redundancy check value (CRC).

Where appropriate, the step sending at least one data message comprises sending a short data message.

Optionally, the short data message comprises a message ID, data pertaining to a payload data and a one byte cyclic redundancy check (CRC8).

Optionally, the short data message is between 3 to 5 bytes long.

Optionally, the message ID of the short message data provides data pertaining to reserved vendor specific data messages.

Optionally, the message ID of the short message data provides data pertaining to number of said payload bytes selected from a group consisting of 1, 2 and 3.

Where appropriate, the step of sending at least one data message comprises sending a long data message, and may further comprise receiving an acknowledged message from the power transmitter coil.

Optionally, the long data message comprises a message ID, data pertaining to a message length, data pertaining to a payload data and a two byte cyclic redundancy check (CRC16).

Optionally, the long data message is of variable length up to 128 bytes long.

Optionally, the message ID of the long message data provides data pertaining to reserved vendor specific data messages.

Optionally, the message length of the long message data is determining the number of bytes that follow excluding said CRC16 number of bytes.

Where appropriate, the step of sending at least one data message comprises sending a receiver advanced capabilities report (RACR) message.

Optionally, the receiver advanced capabilities report (RACR) message comprises a message ID, data pertaining to a message length, data pertaining to a receiver capabilities structure and a two byte cyclic redundancy check (CRC16).

Optionally, the message ID of the receiver advanced capabilities report (RACR) message is set to 0x01 indicating it is representing the receiver advanced capabilities report message.

Optionally, the receiver capabilities structure comprises data pertaining to a power level supported, data pertaining to an extended range support, data pertaining to an extended signaling support, data pertaining to a host control interface (HCI) and data pertaining to received signal strength (SS) support.

Optionally, the message length of the receiver advanced capabilities report (RACR) message is determining the number of bytes that follow excluding said CRC16 number of bytes.

Optionally, the power level supported is selected from a group consisting of: a power class of 5 W, a power class of 10 W, a power class of 15 W, a power class of 20 W, a power class of 30 W, a power class of 40 W, a power class of 50 W and a power class of 70 W.

Optionally, the extended range is selected from a group consisting of standard range, extended range with PMA-1 and extended range without PMA-1.

Optionally, the extended signaling is selected from a group consisting of standard signaling, uni-directional extended signaling, bi-directional extended signaling and bi-directional continuous signaling.

Where appropriate, the step of sending at least one data message when the extended range support is supported comprises sending a consumed power report message.

Optionally, the consumed power report message comprises a message ID, data pertaining to consumed power and a one byte cyclic redundancy check (CRC8).

Where appropriate, the step of sending at least one data message comprises sending an extended EOC report message.

Optionally, the extended EOC report message comprises a message ID, data pertaining to an EOC reason string, data pertaining to a power transmitter coil sleep time recommendation and a one byte cyclic redundancy check (CRC8).

Optionally, the EOC reason string is selected from a group consisting of “battery fully charged”, “no load”, “detection of load disconnection”, “host EOC request”, “incompatible power class”, “over temperature”, “over voltage”, “over current”, “over dec”, “alternate supply connected”, “internal fault”, “voltage stabilization error”, “communication error” and “reconfigure”.

Optionally, the power transmitter coil sleep time recommendation is determined by a sleep code value associated with said sleep time recommendation.

Another aspect of the disclosure is to teach a method for controlling a wireless power transfer system, said wireless power transfer system comprising: at least one wireless power outlet associated with a wireless power transmitter coil and at least one electrical device associated with a wireless power receiver coil, where the wireless power receiver coil is in multi-directional communication with the wireless power transmitter coil, the method comprising the steps of: obtaining a message polling period; receiving at least one message communication from the wireless power transmitter coil; processing received the at least one message communication; and sending at least one response communication to said wireless power transmitter coil.

Where appropriate, the step of receiving at least one message communication further comprising the steps of: sending an MS_Poll request to the at least one power transmitter coil; and receiving at least one data message.

Where appropriate, the step of processing the received at least one message communication further comprising the steps of: decoding the received at least one data message communication; computing a CRC of the received at least one data message communication; if the CRC is valid then sending an acknowledged message; and if the CRC is erroneous then sending an error message.

Where appropriate, the sending of an error message comprises sending a redacted CRC message of the last received correct data message.

Where appropriate, the sending of an acknowledged message comprises sending a redacted CRC message of the received at least one data message communication.

Where appropriate, the step of obtaining a message polling period comprises returning a default message polling period value.

Where appropriate, the step of obtaining a message polling period comprising the steps of: obtaining a recommended message polling period value from the wireless power transmitter coil; and returning said recommended message polling period value.

Where appropriate, the step of receiving at least one data message comprises receiving a transmitter advanced capabilities report (TACR) message.

Optionally, the transmitter advanced capabilities report (TACR) message comprises a message ID, data pertaining to a message length, data pertaining to a transmitter capabilities structure and a two byte cyclic redundancy check (CRC16).

Optionally, the message ID of the transmitter advanced capabilities report (TACR) message is set to 0x01, indicating it is representing said transmitter advanced capabilities report message.

Optionally, the transmitter capabilities structure comprises data pertaining to a power level supported, data pertaining to an extended range support, data pertaining to an extended signaling support, data pertaining to a RXID validation.

It is noted that RXID validation may include an indication for the RXID verification by the wireless power transmitter coil. Optionally, a CRC calculation may be used for the RXID validation, or further the validation value may be retrieved from another database.

Optionally, the message length of the transmitter advanced capabilities report (TACR) message is determining the number of bytes that follow excluding said CRC16 number of bytes.

Optionally, the power level supported is selected from a group consisting of: a power class of 5 W, a power class of 10 W, a power class of 15 W, a power class of 20 W, a power class of 30 W, a power class of 40 W, a power class of 50 W and a power class of 70 W.

Optionally, the extended range is selected from a group consisting of standard range, extended range with PMA-1 and extended range without PMA-1.

Optionally, the extended signaling is selected from a group consisting of standard signaling, uni-directional extended signaling, bi-directional extended signaling and bi-directional continuous signaling.

Where appropriate, the step of receiving at least one data message comprises receiving a polling period configuration (PPC) message.

Optionally, the polling period configuration (PPC) message comprises a message ID, data pertaining to a message length, data pertaining to a polling period and a two byte cyclic redundancy check (CRC16).

Another aspect of the disclosure is to teach a method for controlling a wireless power transfer system, said wireless power transfer system comprising: at least one wireless power outlet associated with a wireless power transmitter coil and at least one electrical device associated with a wireless power receiver coil, where the wireless power receiver coil is in multi-directional communication with the wireless power transmitter coil, the method comprising the steps of: receiving at least one message communication from the wireless power receiver coil; executing instructions encoded in control signals included in the least one message communication; and sending at least one response communication to the wireless power receiver coil.

Where appropriate, the step of receiving at least one message communication further comprising the steps of: receiving a sequence of message initiation signals from the wireless power receiver coil; and receiving at least one data message from the wireless power receiver coil.

Where appropriate, the step of sending at least one response communication further comprising the steps of: receiving a TACK_Poll request; and sending at least one data response to the wireless power receiver coil.

Optionally, the step of receiving at least one data message comprises receiving an RXID message.

Optionally, the RXID message comprises data pertaining to a message preamble, a message ID, an identification string and a cyclic redundancy check value (CRC).

Where appropriate, the step receiving at least one data message comprises receiving a short data message.

Optionally, the short data message comprises a message ID, data pertaining to a payload data and a one byte cyclic redundancy check (CRC8).

Optionally, the short data message is between 3 to 5 bytes long.

Optionally, the message ID of the short data message provides data pertaining to reserved vendor specific data messages.

Optionally, the message ID of the short data message provides data pertaining to number of said payload bytes selected from a group consisting of 1, 2 and 3.

Where appropriate, the step of receiving at least one data message comprises receiving a long data message. Further, the receiving of a long data message further comprising sending an acknowledged message to the power receiver coil.

Optionally, the long data message comprises a message ID, data pertaining to a message length, data pertaining to a payload data and a two byte cyclic redundancy check (CRC16).

Optionally, the long data message is of variable length up to 128 bytes long.

Optionally, the message ID of the long data message provides data pertaining to reserved vendor specific data messages.

Optionally, the message length of the long data message is determining the number of bytes that follow excluding said CRC16 number of bytes.

Where appropriate, the step of receiving at least one data message comprises receiving a receiver advanced capabilities report (RACR) message.

Optionally, the receiver advanced capabilities report (RACR) message comprises a message ID, data pertaining to a message length, data pertaining to a receiver capabilities structure and a two byte cyclic redundancy check (CRC16).

Optionally, the message ID of the receiver advanced capabilities report (RACR) message is set to 0x01 indicating, it is representing said receiver advanced capabilities report message.

Optionally, the receiver capabilities structure comprises data pertaining to a power level supported, data pertaining to an extended range support, data pertaining to an extended signaling support, data pertaining to a host control interface (HCI) and data pertaining to received signal strength (SS) support.

Optionally, the message length of the receiver advanced capabilities report (RACR) message is determining the number of bytes that follow excluding said CRC16 number of bytes.

Optionally, the power level supported is selected from a group consisting of: a power class of 5 W, a power class of 10 W, a power class of 15 W, a power class of 20 W, a power class of 30 W, a power class of 40 W, a power class of 50 W and a power class of 70 W.

Optionally, the extended range is selected from a group consisting of standard range, extended range with PMA-1 and extended range without PMA-1.

Optionally, the extended signaling is selected from a group consisting of standard signaling, uni-directional extended signaling, bi-directional extended signaling and bi-directional continuous signaling.

Where appropriate, the receiving at least one data message and wherein the extended range support is supported comprises receiving a consumed power report message.

Optionally, the consumed power report message comprises a message ID, data pertaining to consumed power and a one byte cyclic redundancy check (CRC8).

Where appropriate, the step of receiving at least one data message comprises receiving an extended EOC report message.

Optionally, the extended EOC report message comprises a message ID, data pertaining to an EOC reason string, data pertaining to a power transmitter coil sleep time recommendation and a one byte cyclic redundancy check (CRC8).

Optionally, the EOC reason string is selected from a group consisting of “battery fully charged”, “no load”, “detection of load disconnection”, “host EOC request”, “incompatible power class”, “over temperature”, “over voltage”, “over current”, “over dec”, “alternate supply connected”, “internal fault”, “voltage stabilization error”, “communication error” and “reconfigure”.

Optionally, the power transmitter coil sleep time recommendation is determined by a sleep code value associated with said sleep time recommendation.

Where appropriate, the step of executing instructions encoded in control signals included in said least one message communication, comprises increasing transfer power wherein said at least one message communication includes PMA_Dec signal.

Where appropriate, the step of executing instructions encoded in control signals included in the least one message communication, comprises decreasing transfer power wherein the at least one message communication includes PMA_Inc signal.

It is noted that the current system is operable above resonance implies that increasing the frequency indicates a requirement to decrease power and vice versa, decreasing frequency requires increasing power.

Another aspect of the disclosure is to teach a method for controlling a wireless power transfer system, said wireless power transfer system comprising: at least one wireless power outlet associated with a wireless power transmitter coil and at least one electrical device associated with a wireless power receiver coil, where the wireless power receiver coil is in multi-directional communication with the wireless power transmitter coil, the method comprising the steps of: sending at least one message communication to said wireless power receiver coil; receiving at least one response communication from said wireless power receiver coil; and processing said at least one response communication.

Where appropriate, the step of sending at least one message communication further comprising the steps of: receiving an MS_Poll request from the at least one power receiver coil; and sending at least one data message from the wireless power transmitter to the wireless power receiver.

Optionally, the message communication from the wireless power transmitter may be transmitted by modulating the operating frequency by 5 kilohertz to 10 kilohertz above the operating point.

Where appropriate, the step of processing at least one response communication further comprising the steps of: decoding the at least one data response communication; computing a CRC of the at least one data response communication; if the CRC is valid then sending an acknowledged message; and if the CRC is erroneous then sending an error message.

Where appropriate, the step of sending at least one data message comprises sending a transmitter advanced capabilities report (TACR) message.

Optionally, the transmitter advanced capabilities report (TACR) message comprises a message ID, data pertaining to a message length, data pertaining to a transmitter capabilities structure and a two byte cyclic redundancy check (CRC16).

Optionally, the message ID of the transmitter advanced capabilities report (TACR) message is set to 0x01, indicating it is representing said transmitter advanced capabilities report message.

Optionally, the transmitter capabilities structure comprises data pertaining to a power level supported, data pertaining to an extended range support, data pertaining to an extended signaling support, data pertaining to a RXID validation.

Optionally, the message length of the transmitter advanced capabilities report (TACR) message is determining the number of bytes that follow excluding said CRC16 number of bytes.

Optionally, the power level supported is selected from a group consisting of: a power class of 5 W, a power class of 10 W, a power class of 15 W, a power class of 20 W, a power class of 30 W, a power class of 40 W, a power class of 50 W and a power class of 70 W. It is noted that in general, power classes are set according to drawn power by the load device at receiver output. More power must be driven by the transmitter due to efficiency <100%.

Optionally, the extended range is selected from a group consisting of standard range, extended range with PMA-1 and extended range without PMA-1.

Optionally, the extended signaling is selected from a group consisting of standard signaling, uni-directional extended signaling, bi-directional extended signaling and bi-directional continuous signaling.

Optionally, the RXID validation is indicating RXID verification by the wireless power transmitter coil.

Where appropriate, the step of sending at least one data message comprises sending a polling period configuration (PPC) message.

Optionally, the polling period configuration (PPC) message comprises a message ID, data pertaining to a message length, data pertaining to a polling period and a two byte cyclic redundancy check (CRC16).

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a block diagram showing the main elements of an inductive power transfer system with a feedback signal path according to embodiments of the present invention;

FIG. 2 is a graph showing how the amplitude of operational voltage of an inductive power transfer system varies with transmission frequency;

FIG. 3 is a schematic diagram representing a laptop computer drawing power from an inductive power outlet;

FIG. 4 is a circuit diagram of an inductive power transfer system according to another embodiment of the invention including a peak detector for detecting large increases in transmission voltage;

FIG. 5 is a flowchart showing a method for regulating power transfer by varying the power transmission frequency in an inductive power transfer system according to a further embodiment of the invention;

FIG. 6 is a block diagram showing the main elements of an inductive power transfer system with an inductive feedback channel according to still another embodiment of the present invention;

FIG. 7 is a graph showing how the variation of operational voltage with transmission frequency is affected by changes in resonant frequency of the system;

FIG. 8 is a circuit diagram of an inductive power transfer system including an inductive feedback channel for providing coil-to-coil signal transfer concurrently with uninterrupted inductive power transfer between the coils in accordance with yet another embodiment of the invention;

FIG. 9 is a flowchart showing a method for inductively transferring a signal from the secondary inductive coil to a primary inductive coil of an inductive power transfer system according to still a further embodiment of the invention;

FIG. 10A is a block diagram representing selected components of an energy efficient inductive power transfer system incorporating activation and termination mechanisms;

FIG. 10B is a flowchart representing transition between standby mode and transmission mode for activating and terminating an energy efficient inductive power transfer system;

FIG. 11A is a schematic representation of a possible general message byte structure of a power receiver coil extended signaling message;

FIG. 11B is a schematic representation of possible power transmitter coil byte transmission format of a power transmitter coil extended signaling message;

FIG. 12 is a graph showing an illustration of extended signaling flow coupled with standard signaling flow;

FIG. 13A is a schematic representation of a possible control message format of the extended communication signaling;

FIG. 13B is a schematic representation of a possible short message format of the extended communication signaling;

FIG. 13C is a schematic representation of a possible long message format of the extended communication signaling;

FIG. 14A is a flowchart representing selected actions of a possible method for message transmission sequence by a power receiver coil;

FIG. 14B is a flowchart representing selected actions of a possible method for message receiving sequence of a power receiver coil;

FIG. 14C is a flowchart representing selected actions of a possible method for message receiving sequence of a power transmitter coil;

FIG. 14D is a flowchart representing selected actions of a possible method for message transmission sequence of a power transmitter coil;

FIG. 15A is a flowchart representing selected actions of a possible method for message transmission in a uni-directional communication channel;

FIG. 15B is a flowchart representing selected actions of a possible method for short message transmission flow in a bi-directional communication channel;

FIG. 15C is a flowchart representing selected actions of a possible method for long message transmission flow in a bi-directional communication channel;

FIG. 16A is a schematic representation of a possible receiver advanced capabilities reporting (RACR) message format of the extended communication signaling;

FIG. 16B is a schematic representation of a possible receiver advanced capabilities sub-structure format details of the extended communication signaling;

FIG. 16C is a schematic representation of a possible transmitter advanced capabilities reporting (TACR) message format of the extended communication signaling;

FIG. 16D is a schematic representation of a possible transmitter advanced capabilities sub-structure format details of the extended communication signaling;

FIG. 17 is a flowchart representing selected actions of a possible method for supporting extended power transmission in a bi-directional and possibly in a continuous bi-directional extended signaling communication channel;

FIG. 18 is showing a power receiver extended timing table;

FIG. 19 is a schematic representation of a possible extended EOC report message format of the extended communication signaling;

FIG. 20 is showing an EOC reason table of possible values for the extended EOC report message EOC reason field;

FIG. 21 is showing a power transmitter sleep time table including sleep codes and possible sleep time recommendations;

FIG. 22 is a schematic representation of a possible consumed power report message format of the extended communication signaling; and

FIG. 23 is a schematic representation of a possible polling period configuration message format of the extended communication signaling.

### DESCRIPTION OF THE PREFERRED EMBODIMENTS

Aspects of the present invention relate to providing devices, systems and methods for energy efficient wireless power transfer. In particular, the disclosure relates to incorporating extended signaling supporting multi-directional communication to enable data transfer, higher power levels over extended range and improved foreign object detection (FOD) functionality.

It is noted that the extended signaling may also provide ability to transfer relatively low quantities of data from a power receiver coil connectable to a load, to a power transmitter coil.

It is further noted that the protocol of transferring data, from a power receiver coil to a power transmitter coil and vice versa, may be used for in band communication utilizing the medium used to transfer PMA signals or for out of band (OOB) communication channels like Bluetooth Low Energy (BLE), WiFi, audio communication, ultrasonic communication and the like.

It is noted that that the extended protocol allows the options of starting communication in an in-band mode and switching to out of band communication channels during wireless power transfer. For example, an in-band communication channel may transfer signals may be used during the initiation phase and subsequently, an out-of-band communication channel may be used for ongoing communication during stable periods of power transfer.

As used herein, the term “CRC” refers to Cyclic Redundancy Code, used to ensure continued data integrity and enabling to detect data corruption in a network environment. Recalculating the CRC and comparing it to the value originally transmitted, the receiver may detect various transmission errors. The CRC may be calculated using division either shifts and exclusive ORs or table lookup.

As used herein, the term “EOC” is an abbreviation of End of Charge.

As used herein, the term “FOD” is an abbreviation of Foreign Object Detection.

As used herein, the term “LSB” is an abbreviation of Least Significant Bit.

As used herein, the term “MSB” is an abbreviation of Most Significant Bit.

As used herein, the term “RXID” is the Unique ID of a compliant receiver.

As used herein, the term Rx is a wireless power receiver.

As used herein, the term Tx is a wireless power transmitter.

The wireless power transfer system's basic functionality, may include a receiver to regulate the output voltage and to control the received power by modulating the power signal according to a suitable communication protocol; a transmitter (also referred to as an outlet), demodulates the signals and changes the frequency to adjust the delivered power; and by controlling the operation frequency, delivered power from the transmitter to the receiver may be increased and decreased.

The amount of power transferred is controlled by sending feedback communication from the receiver to the transmitter (e.g., to increase or decrease power). The receiver may communicate with the transmitter by changing the load seen by the transmitter. This load variation results in a change in the transmitter coil current, which is measured and interpreted by a processor in the charging surface. The wireless power transfer system uses frequency-based signaling extended protocol. It also includes identification and end of power transfer (charging) signals.

The wireless power transfer system may be in one of the following phases: Standby; Digital Ping; Identification; Power Transfer; and End of Charge (EOC).

### Extended Signaling Categories:

The extended signaling may be divided into three categories: Unidirectional; Bi-directional; and Continuous Bi-directional.

The unidirectional signaling category supports traffic from power receiver coil to power transmitter coil only, providing required signaling to enable implementing some extended functions required.

The bi-directional signaling category relates to bi-directional traffic capability between power receiver coil and power transmitter coil during the identification phase, providing required signaling to enable implementing some of the functional extensions such as providing and controlling increased power support.

The continuous bi-directional signaling category defines continuous bi-directional traffic between power receiver coil and power transmitter coil during the power transfer phase. The continuous bi-directional signaling category is provided for completeness aiming at possible future functional extensions in aspects of the various signaling phases.

The extended communication protocol may provide various data reliability levels to answer different functions requirements related to the traffic between power receiver coil and power transmitter coil.

Semi-reliable data communication may provide fast unacknowledged messaging that may be mostly used for periodic reports.

Full reliability of data, with acknowledged messaging that may be used mostly for configuration of data exchanges.

### Backward Compatibility:

With current disclosure, usage of the extended communication protocol may support backward compatibility. It is intended that higher power transmitter coil will maintain backward compatibility, enabling to charge standard 5 W devices. Further, higher power receiver devices will be able to operate on the higher power level when placed on power transmitter coil that supports the higher power level and will operate using lower power level when placed on a power transmitter coil supporting only the standard 5 W output power.

Accordingly, negotiation of capabilities and a synchronized switch (transition) to higher power operation is required.

The specific messaging for capability exchange and protocol level selection is defined. In addition the required messages and exchanges for establishment of higher power connection between and power transmitter coil are also defined.

Additional signaling from power receiver coil to provide power transmitter coil with information regarding EOC cause is defined, this will enable to improve user experience and allow power transmitter coil to define different sleep strategies depending on EOC cause.

A continuous report of power receiver coil consumed power is defined. The defined report will assist in implementation of a more robust Foreign object Detection (FOD) mechanism required for extended range operation.

### DESCRIPTION OF THE EMBODIMENTS

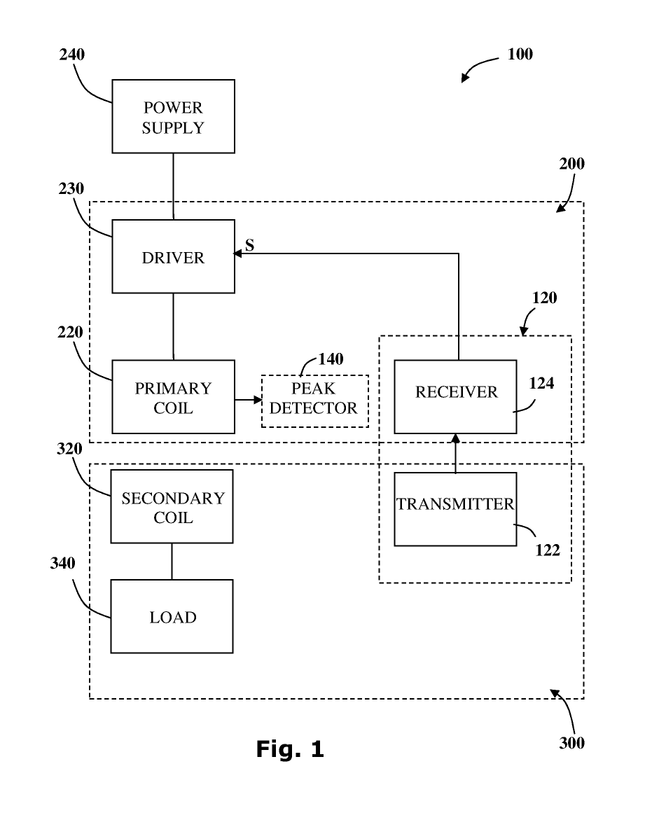

Reference is now made to FIG. 1 showing a block diagram of the main elements of an inductive power transfer system 100 adapted to transmit power at a non-resonant frequency according to another embodiment of the invention. The inductive power transfer system 100 consists of an inductive power outlet 200 configured to provide power to a remote secondary unit 300. The inductive power outlet 200 includes a primary inductive coil 220 wired to a power source 240 via a driver 230. The driver 230 is configured to provide an oscillating driving voltage to the primary inductive coil 220.

The secondary unit 300 includes a secondary inductive coil 320, wired to an electric load 340, which is inductively coupled to the primary inductive coil 220. The electric load 340 draws power from the power source 240. A communication channel 120 may be provided between a transmitter 122 associated with the secondary unit 300 and a receiver 124 associated with the inductive power outlet 200. The communication channel 120 may provide feedback signals S and the like to the driver 230.

In some embodiments, a voltage peak detector 140 is provided to detect large increases in the transmission voltage. As will be descried below the peak detector 140 may be used to detect irregularities such as the removal of the secondary unit 200, the introduction of power drains, short circuits or the like.

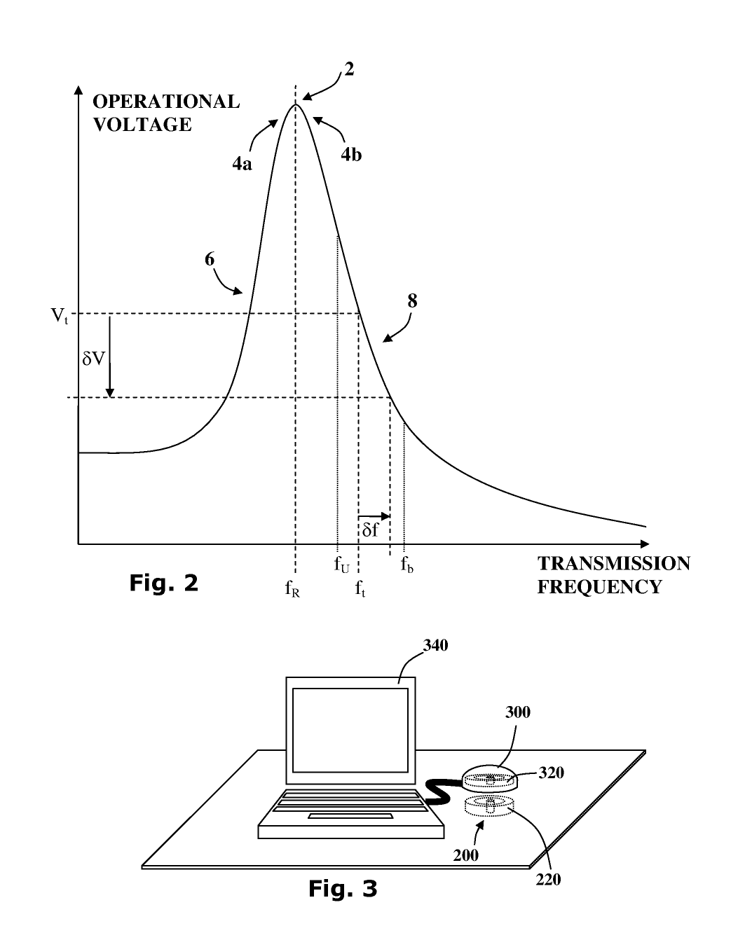

FIG. 2 is a graph showing how the amplitude of the operational voltage of an inductive power transfer system varies according to the transmission frequency. It is noted that the voltage is at its highest when the transmission frequency is equal to the resonant frequency f_{R} of the system, this maximum amplitude is known as the resonance peak 2. It is further noted that the slope of the graph is steepest in the regions 4a, 4b to either side of the resonance peak 2. Thus in inductive transfer systems, which operate at or around resonance, a small variation in frequency results in a large change in induced voltage. Similarly, a small change in the resonant frequency of the system results in a large change in the induced voltage. For this reason prior art resonant inductive transfer systems are typically very sensitive to small fluctuations in environmental conditions or variations in alignment between the induction coils.

It is a particular feature of embodiments of the current invention that the driver 230 (FIG. 1) is configured and operable to transmit a driving voltage which oscillates at a transmission frequency which is substantially different from the resonant frequency of the inductive couple. Optionally the transmission frequency is selected to lie within one of the near-linear regions 6, 8 where the slope of the frequency-amplitude graph is less steep.

One advantage of this embodiment of the present invention may be demonstrated with reference now to FIG. 3. A schematic diagram is shown representing a laptop computer 340 drawing power from an inductive power outlet 200 via a secondary power receiving unit 300. The power receiving unit 300 includes a secondary inductive coil 320 which is aligned to a primary inductive coil 220 in the inductive power outlet 200. Any lateral displacement of the secondary power receiving unit 300 changes the alignment between the secondary inductive coil 320 to the primary inductive coil 220. As a result of the changing alignment, the combined inductance of the coil pair changes which in turn changes the resonant frequency of the system.

If the inductive power outlet 200 transmits power at the resonant frequency of the system, even a small lateral movement would reduce significantly the amplitude of the induced voltage. In contradistinction to the prior art, in embodiments of the present invention the inductive power outlet 200 transmits power at a frequency in one of the regions 6, 8 to either side of the resonance peak 2 (FIG. 2) where the slope of the resonance graph is much shallower. Consequently, the system has a much larger tolerance of variations such as lateral movement.

A further feature of embodiments of inductive power outlets transmitting at frequencies above the natural resonant frequency of the system, is that if the resonant frequency of the system increases for some reasons, then the transmission voltage increases sharply. In preferred embodiments, a peak detector 140 (FIG. 1) is be provided to monitor the transmission voltage of the power outlet 200 and is configured to detect large increases in the transmission voltage indicating an increase in resonant frequency.

Referring again to the resonant formula for inductive systems,

$${f}_{R} = \frac{1}{2 π \sqrt{LC}} ,$$

it is noted that any decrease in either the inductance L or the capacitance C of the system increases the resonant frequency and may be detected by the peak detector 140.

As an example of the use of a peak detector 140, reference is again made to FIG. 3. It will be appreciated that in a desktop environment, conductive bodies such as a paper clip, metal rule, the metal casing a stapler, a hole-punch or any metallic objects may be introduced between the inductive power outlet 200 and the secondary power receiving unit 300. The oscillating magnetic field produced by the primary coil 220 would then produce eddy currents in the conductive body heating it and thereby draining power from the primary coil 220. Such a power drain may be wasteful and/or dangerous. Power drains such as described above generally reduce the inductance L of the system thereby increasing its resonant frequency.

The inductance L of the system may also be reduced by the removal of the secondary coil 220, the creation of a short circuit or the like. A peak detector 140, wired to the inductive power outlet, may detect any of these scenarios as a large increase in transmission voltage. Where required, the power transfer system may be further configured to shut down, issue a warning or otherwise protect the user and the system in the event that the peak detector 140 detects such an increase in transmission voltage.

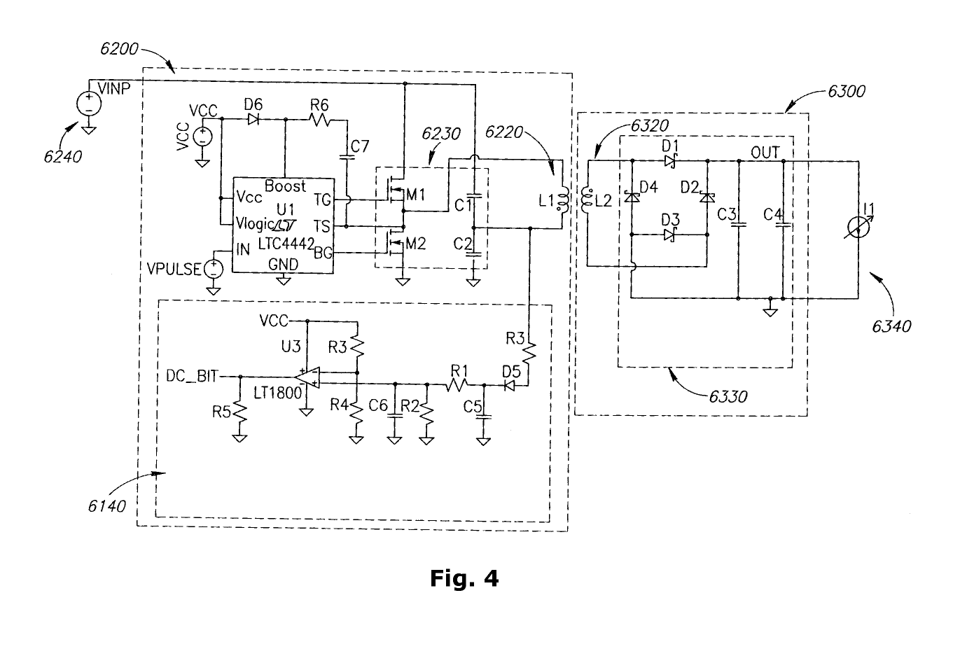

FIG. 4 is a circuit diagram of an inductive power outlet 6200 and secondary unit 6300. The secondary unit 6300 comprises a secondary coil 6320 wired to an electric load 6340 via a rectifier 6330.

The inductive power outlet 6200 comprises a primary coil 6220 driven by a half-bridge converter 6230 connected to a power source 6240. The half-bridge converter 6230 is configured to drive the primary coil 6220 at a frequency higher than the resonant frequency of the system and a peak detector 6140 is configured to detect increases in the transmission voltage.

Although only a half-bridge converter is represented in FIG. 4, it is noted that other possible driving circuits include: a DC-to-DC converter, an AC-to-DC converter, an AC-to-AC converter, a flyback transformer, a full-bridge converter, a flyback converter or a forward converter for example.

Another advantage of non-resonant transmission is that the transmission frequency may be used to regulate power transfer. Prior art inductive power transfer systems, typically regulate power transfer by altering the duty cycle of the transmission voltage. Unlike prior art systems, because embodiments of the present invention transmit at a frequency not equal to the resonant frequency of the system, the driver 230 may be configured to regulate power transfer by adjusting the transmission frequency.

The regulation is illustrated with reference to FIG. 2. In embodiments of the invention, the frequency of transmission may be selected to be in the approximately linear region 8 of the curve between a lower frequency value of f_{L} and an upper frequency value of f_{U}. A transmission frequency fₜ, higher than the resonant frequency f_{R} of the system, produces an induced voltage of Vₜ. The induced voltage can be increased by reducing the transmission frequency so that it is closer to the resonant frequency f_{R}. Conversely, the induced voltage may be reduced by increasing the transmission frequency so that it is further from the resonant frequency f_{R}. For example, an adjustment of transmission frequency by δf produces a change in induced voltage of δV.

In some embodiments, a communication channel 120 (FIG. 1) is provided between the secondary unit 300 and the inductive power outlet 200 to communicate the required operating parameters. In embodiments of the invention operating parameters the communication channel 120 may be used to indicate the transmission frequency required by the electric load 340 to the driver 230.

The communication channel 120 may further provide a feedback signal during power transmission. The feedback transmission may communicate required or monitored operating parameters of the electric load 240 such as:
required operating voltage, current, temperature or power for the electric load 240,
the measured voltage, current, temperature or power supplied to the electric load 240 during operation,
the measured voltage, current, temperature or power received by the electric load 240 during operation and the like.

In some embodiments, a microcontroller in the driver 230 may use such feedback parameters to calculate the required transmission frequency and to adjust the driver accordingly. Alternatively, simple feedback signals may be provided indicating whether more or less power is required.

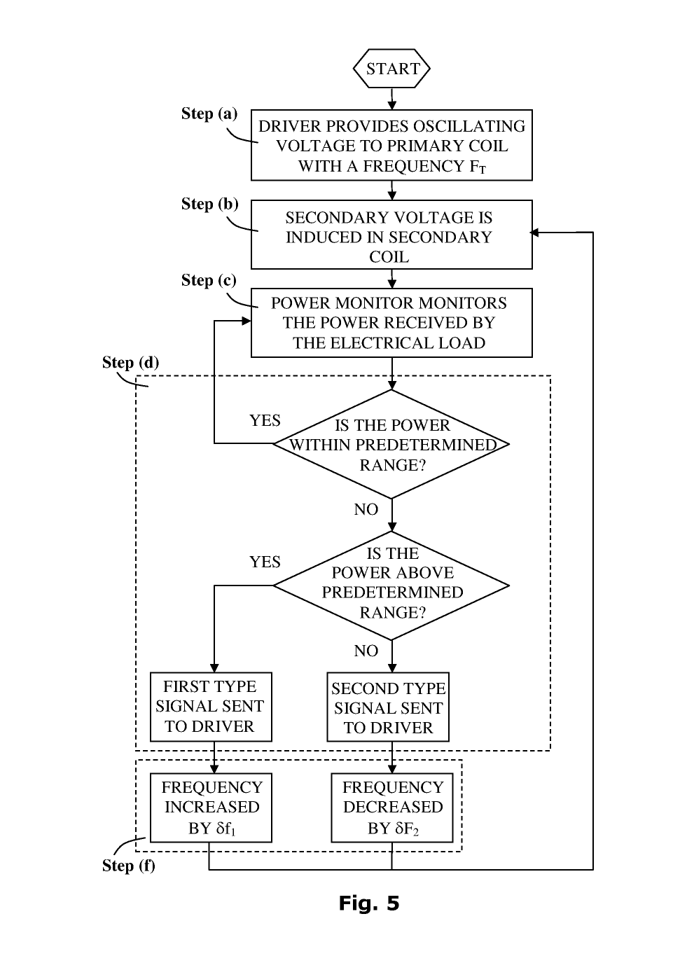

One example of a power regulation method using simple feedback signals is shown in the flowchart of FIG. 5. The method involves the following steps:

Step (a)—The driver 230 provides an oscillating voltage at a transmission frequency fₜ which is higher than the resonant frequency f_{R} of the system.
Step (b)—A secondary voltage is induced in the secondary coil 320.
Step (c)—A power monitor in the secondary unit 300, monitors the power received by the electric load 340.
Step (d)—If the power received by the electric load 340 lies within a predetermined range then no action is taken. If the power received by the electric load 340 is below the predetermined range, then a feedback signal of a first type Sₐ is sent to the driver. If the power received by the electric load 340 is above the predetermined range, then a feedback signal of a second type S_{b} is sent to the driver.
Step (e)—A feedback signal is received by the driver 230.
Step (f)—If the received feedback signal is of the first type Sₐ, then the transmission frequency is increased by an incremental value+δf₁. If the received feedback signal is of the second type S_{b}, then the transmission frequency is decreased by an incremental value−δf₂.

It is noted that by using the power regulation method described above, when the power received by the load is too high, a series of feedback signals of the first type Sₐ will be transmitted until the power is reduced into the acceptable range. Likewise when the power received by the load is too low, a series of feedback signals of the second type S_{b} will be transmitted until the power is increased into the acceptable range. It is noted that the positive incremental value δf₁ may be greater than, less than or equal to the negative incremental value δf₂.

Alternatively, other power regulation methods using frequency adjustment may be used. For example, the operating parameters of the electric load may be monitored and their values may be transmitted to the power outlet via the communications channel 120. A processor in the power outlet may then calculate the required transmission frequency directly.

The method described hereinabove, refers to a non-resonant transmission frequency lying within the linear region 8 (FIG. 2), higher than the resonant peak 2. It will be appreciated however that in alternative embodiments frequency-controlled power regulation may be achieved when the transmission frequency lies in the lower linear region of the resonance curve. Nevertheless, for certain embodiments, the selection of transmission frequencies in the higher linear 8 may be preferred, particularly where peak detection, as described above, is required.

Referring back to FIG. 1, various transmitters 122 and receivers 124 may be used for the communication channel 120. Where, as is often the case for inductive systems, the primary and secondary coils 220, 320 are galvanically isolated optocouplers, for example, may be used. A light emitting diode serves as a transmitter and sends encoded optical signals over short distances to a photo-transistor which serves as a receiver. However, optocouplers typically need to be aligned such that there is a line-of-sight between transmitter and receiver. In systems where alignment between the transmitter and receiver may be difficult to achieve, optocoupling may be inappropriate and alternative systems may be preferred such as ultrasonic signals transmitted by piezoelectric elements or radio signals such as Bluetooth, WiFi and the like. Alternatively the primary and secondary coils 220, 320 may themselves serve as the transmitter 122 and receiver 124.

In certain embodiments, an optical transmitter, such as a light emitting diode (LED) for example, is incorporated within the secondary unit 300 and is configured and operable to transmit electromagnetic radiation of a type and intensity capable of penetrating the casings of both the secondary unit 300, and the power outlet 200. An optical receiver, such as a photodiode, a phototransistor, a light dependent resistors of the like, is incorporated within the power outlet 200 for receiving the electromagnetic radiation.

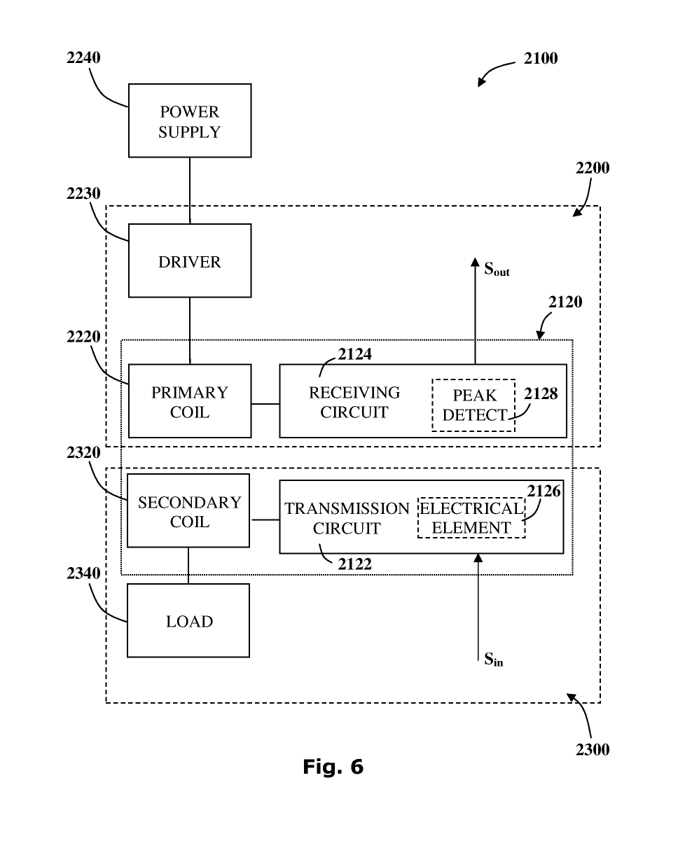

Reference to the block diagram of FIG. 6, it is a particular feature of certain embodiments of the invention that an inductive communications channel 2120 is incorporated into the inductive power transfer system 2100 for transferring signals between a inductive power outlet 2200 and a remote secondary unit 2300. The communication channel 2120 is configured to produce an output signal Sₒᵤₜ in the power outlet 2200 when an input signal Sᵢₙ is provided by the secondary unit 2300 without interupting the inductive power transfer from the outlet 2200 to the secondary unit 2300.

The inductive power outlet 2200 includes a primary inductive coil 2220 wired to a power source 2240 via a driver 2230. The driver 2230 is configured to provide an oscillating driving voltage to the primary inductive coil 2220, typically at a voltage transmission frequency fₜ which is higher than the resonant frequency f_{R} of the system.

The secondary unit 2300 includes a secondary inductive coil 2320, wired to an electric load 2340, which is inductively coupled to the primary inductive coil 2220. The electric load 2340 draws power from the power source 2240. Where the electric load 2340 requires a direct current supply, for example a charging device for an electrochemical cell or the like, a rectifier 2330 may be provided to rectify the alternating current signal induced in the secondary coil 2320.

An inductive communication channel 2120 is provided for transferring signals from the secondary inductive coil 2320 to the primary inductive coil 2220 concurrently with uninterrupted inductive power transfer from the primary inductive coil 2220 to the secondary inductive coil 2320. The communication channel 2120 may provide feedback signals to the driver 2230.

The inductive communication channel 2120 includes a transmission circuit 2122 and a receiving circuit 2124. The transmission circuit 2122 is wired to the secondary coil 2320, optionally via a rectifier 2330, and the receiving circuit 2124 is wired to the primary coil 2220.

The signal transmission circuit 2122 includes at least one electrical element 2126, selected such that when it is connected to the secondary coil 2320, the resonant frequency f_{R} of the system increases. The transmission circuit 2122 is configured to selectively connect the electrical element 2126 to the secondary coil 2320. As noted above, any decrease in either the inductance L or the capacitance C increases the resonant frequency of the system. Optionally, the electrical element 2126 may be have a low resistance for example, with a resistance say under 50 ohms and Optionally about 1 ohm.

It is particularly noted that the electrical element 2126, such as a resistor for example, may act to change the effective resonant frequency of the system by damping or undamping the system and thereby adjusting the quality factor of thereof.

Typically, the signal receiving circuit 2124 includes a voltage peak detector 2128 configured to detect large increases in the transmission voltage. In systems where the voltage transmission frequency fₜ is higher than the resonant frequency f_{R} of the system, such large increases in transmission voltage may be caused by an increase in the resonant frequency f_{R} thereby indicating that the electrical element 2126 has been connected to the secondary coil 2320. Thus the transmission circuit 2122 may be used to send a signal pulse to the receiving circuit 2124 and a coded signal may be constructed from such pulses.

According to some embodiments, the transmission circuit 2122 may also include a modulator (not shown) for modulating a bit-rate signal with the input signal Sᵢₙ. The electrical element 2126 may then be connected to the secondary inductive coil 2320 according to the modulated signal. The receiving circuit 2124 may include a demodulator (not shown) for demodulating the modulated signal. For example the voltage peak detector 2128 may be connected to a correlator for cross-correlating the amplitude of the primary voltage with the bit-rate signal thereby producing the output signal Sₒᵤₜ.

In other embodiments, a plurality of electrical elements 2126 may be provided which may be selectively connected to induce a plurality of voltage peaks of varying sizes in the amplitude of the primary voltage. The size of the voltage peak detected by the peak detector 2128 may be used to transfer multiple signals.

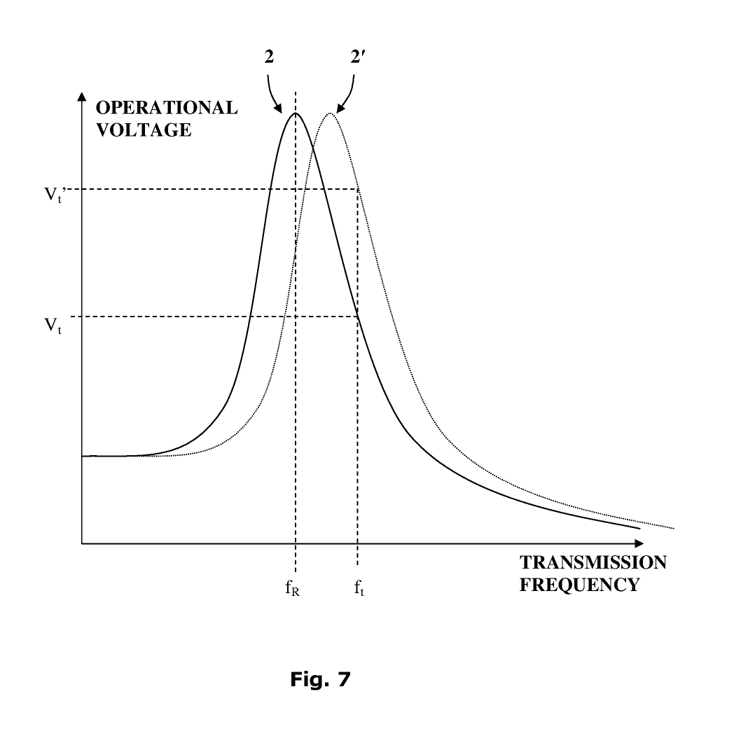

FIG. 7 is a graph showing how the amplitude of the operational voltage varies according to the transmission frequency. It is noted that the voltage is at its highest when the transmission frequency is equal to the resonant frequency f_{R} of the system, this maximum amplitude is known as the resonance peak 2. If the resonant frequency f_{R} of the system increases, a new resonance peak 2′ is produced.

According to another embodiment of the invention, an inductive power transfer system 2100 operates at a given transmission frequency fₜ which is higher than the resonant frequency f_{R} of the system. The normal operating voltage Vₜ is monitored by the voltage peak detector 2128. When the electric element 2126 is connected to the secondary inductive coil 2320 the resonant frequency of the system increases. Therefore, the operating voltage increases to a higher value Vₜ′. This increase is detected by the voltage peak detector 2128.

It is noted that in contradistinction to prior art inductive signal transfer systems such as described in U.S. Pat. No. 5,455,466 to Terry J. Parks and David S. Register, the present invention enables data signals to be transferred from the secondary coil 2320 to the primary coil 2220 concurrently with inductive transfer of power from the primary coil 2220 to the secondary coil 2320. Consequently, the signal transfer system may be used to provide feedback signals for real time power regulation.

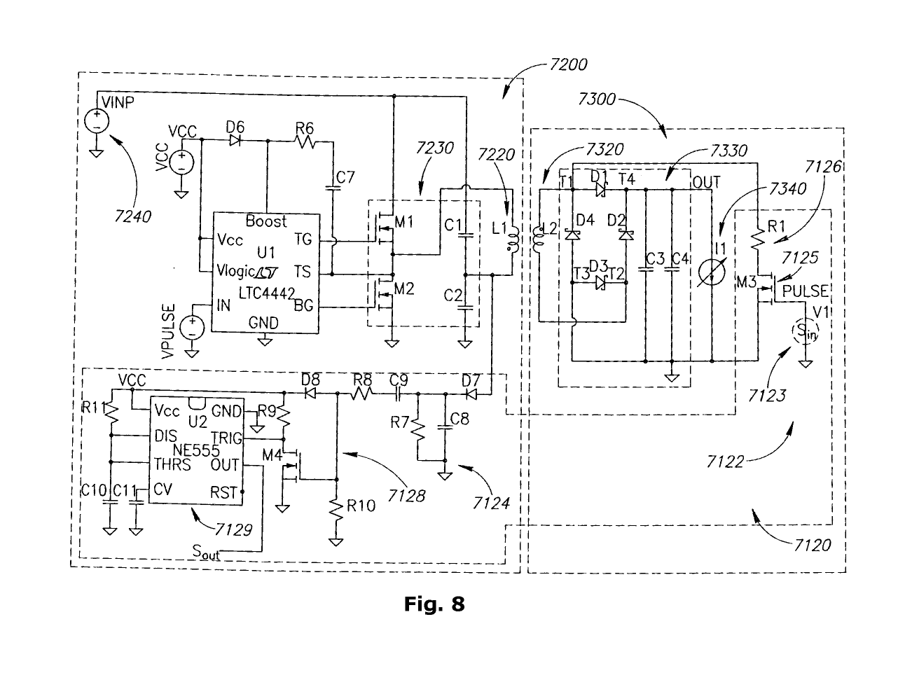

FIG. 8 shows an exemplary circuit diagram of an inductive power outlet 7200 and a secondary unit 7300, according to another embodiment of the invention. An inductive feedback channel 7120 is provided for transferring signals between the coils concurrently with uninterrupted inductive power transfer.

The inductive power outlet 7200 comprises a primary coil 7220 driven by a half-bridge converter 7230 connected to a power source 7240. The half-bridge converter 7230 is configured to drive the primary coil 7220 at a frequency higher than the resonant frequency of the system. The secondary unit 7300 comprises a secondary coil 7320 wired to the input terminals T₁, T₂ of a rectifier 7330, and an electric load 7340 wired to the output terminals T₃, T₄ of the rectifier 7330.

The inductive feedback channel 7120 comprises a transmission circuit 7122, in the secondary unit 7300 and a receiving circuit 7124 in the inductive power outlet 7200. The transmission circuit 7122 comprises an electrical resistor 7126 connected to the rectifier 7330 via a power MOSFET switch 7125. A modulator 7123 may provide an input signal Sᵢₙ to the power MOSFET 7125.

It is noted that in this embodiment the transmission circuit 7122 is wired to one input terminal T₁ and one output terminal T₃ of the rectifier 7330. This configuration is particularly advantageous as, even when the transmission circuit 7122 is connected, the resistor 7126 only draws power from the system during one half of the AC cycle, thereby significantly reducing power loss.

The receiving circuit 7124 includes a voltage peak detector 7128 that is configured to detect increases in the transmission voltage, and a demodulator 7129 for producing an output signal Sₒᵤₜ.

With reference now to FIG. 9, a flowchart is presented showing the main steps in a method for transferring a signal from the secondary inductive coil to a primary inductive coil of an inductive power transfer system. The method includes the following steps:

Step (i)—connecting the primary inductive coil to a voltage monitor for monitoring the amplitude of a primary voltage across the primary coil;
Step (ii)—connecting the secondary inductive coil to a transmission circuit for selectively increasing the resonant frequency of the inductive power transfer system;
Step (iii)—providing an oscillating voltage to the primary inductive coil at an initial transmission frequency higher than the resonant frequency thereby inducing a voltage in the secondary inductive coil;
Step (iv)—using the transmission circuit to modulate a bit-rate signal with the input signal to create a modulated signal and connecting the electrical element to the secondary inductive coil intermittently according to the modulated signal, and
Step (v)—using the voltage monitor to cross-correlate the amplitude of the primary voltage with the bit-rate signal for producing an output signal.

Therefore, the inductive communication channel 2120 may be used to transfer a feedback signal from the secondary inductive coil to the primary inductive coil for regulating power transfer across an inductive power coupling as described above.

It is noted, with regard to step (iii) that in order to extend the range of operation, it is aimed to get closer to the resonant frequency.

It will be appreciated that embodiments of the present invention may be useful in a wide range of applications. Inductive power receivers may be used to wirelessly provide power for a variety of electrical devices. Embodiments of the present invention may be integrated into such inductive power receivers. In particular, because non-resonant transmission uses lower transmission voltages, heat loss from the non-resonant system is lower. Thus embodiments of the current invention may be of particular use when incorporated within high power applications such as power tools, kitchen appliances, bathroom appliances, computers, media players, office equipment and the like.

The reduced heat loss, associated with embodiments of the non-resonant systems of the invention, is particularly useful when heat dissipation is difficult for example when power receiver has small dimensions or for heat-sensitive equipment such as measuring devices. Also, it is desirable that devices implanted into a living body do not dissipate large amounts of heat into the body. Therefore, non-resonant inductive transfer is well suited to implanted devices, such as pace makers, trackers and the like.

It is also noted that in recent years public concern about the threat of a global energy crisis has resulted in a greater emphasis being placed upon optimizing the efficiency of energy transfer. It is difficult to achieve more demanding specifications using existing technology and, in this context, embodiments of the present invention may be used to provide high powers with very low energy losses. Consequently the current invention is an important element in the drive for greater efficiency.

Furthermore embodiments of the present invention may be advantageously utilized in inductive power transfer systems in any of the various applications in which power is transferred from a primary coil to a remote secondary coil. Amongst others, such applications include:
inductive chargers for use charging electronic devices,
inductive power adaptors for powering electronic devices such as computers, televisions, kitchen appliances, office equipment and the like,
medical applications in which power is transferred remotely to devices implanted in a patient,
communications with remote RFID tags,
military application in which power is transferred across thick armored plating,
communication or inductive energy transfer to secondary inductive coils buried underground.
communication or inductive energy transfer to secondary inductive coils submerged under water, for example in submarine applications, and
communication or inductive energy with secondary coils which are moving relative to the primary coil.

Thus, by using a transmission voltage oscillating at a frequency different from the resonant frequency of the system, the inductive transfer system has a higher tolerance to environmental fluctuations and variations in inductive coil alignment than other transfer systems and the frequency may be used to regulate power transfer. Moreover, when the transmission frequency is higher than the resonant frequency of the system, a peak detector may be used to indicate hazards and provide an inductive communication channel.

### Energy Efficient Inductive System

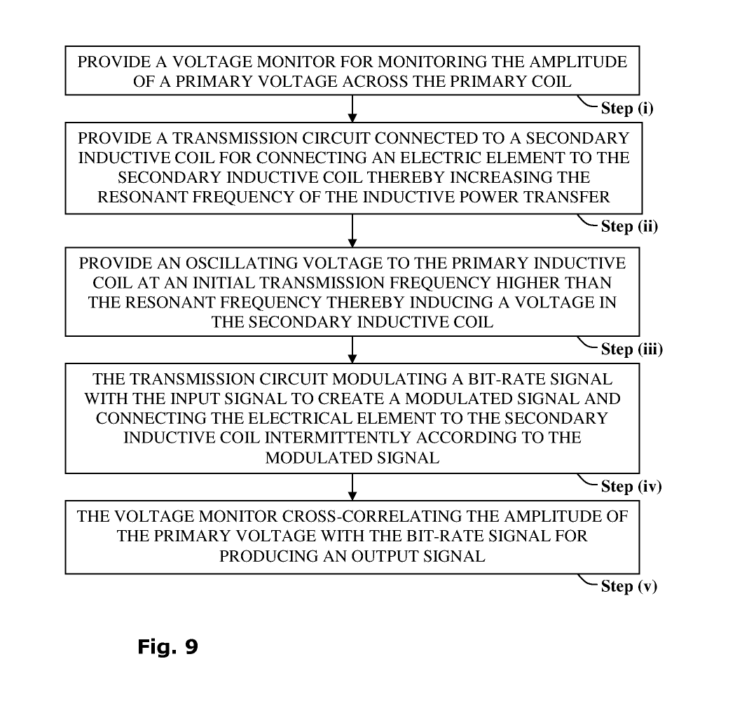

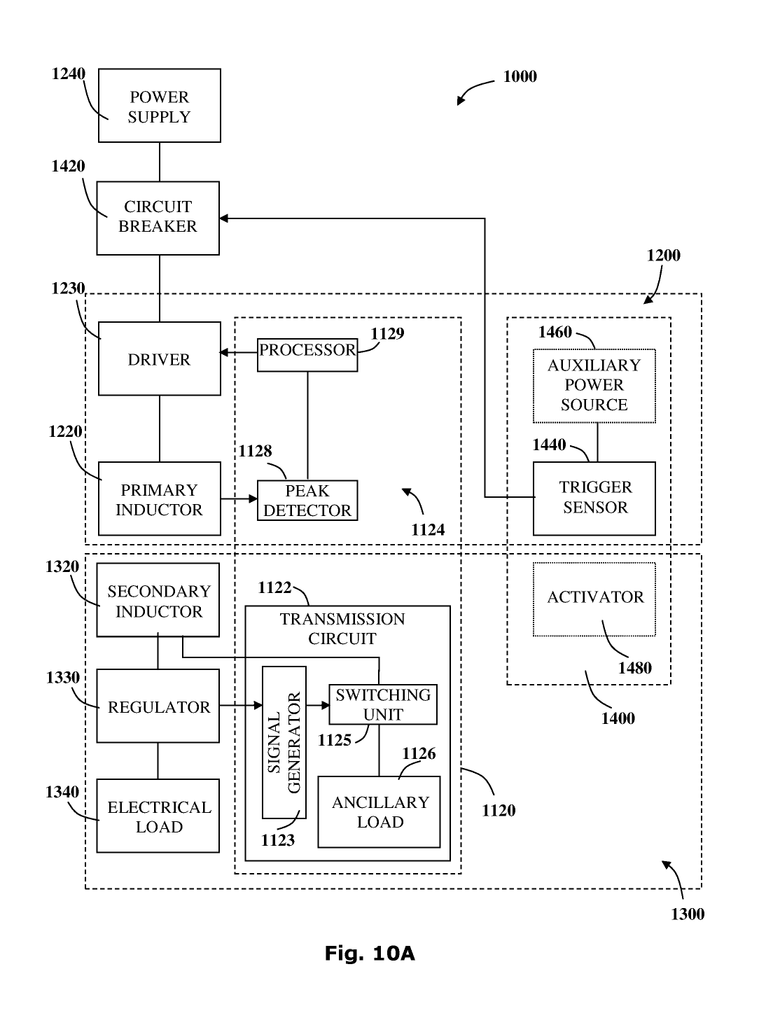

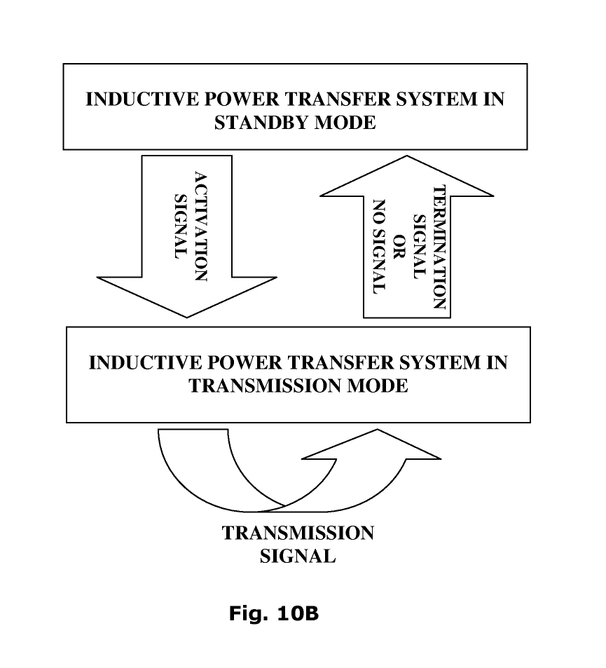

Reference is now made to the block diagram of FIG. 10A representing selected components of an embodiment of an energy efficient inductive power transfer system 1000. The inductive power transfer system 1000 includes an inductive power outlet 1200 and an inductive power receiver 1300 and is configured to switch between transmission mode and standby mode.

In standby mode, the system 1000 may be dormant with the inductive power outlet 1200 and inductive power receiver 1300 waiting for an activation signal before transitioning to transmission mode. In transmission mode, the inductive power system 1000 is configured and operable to draw power from a power supply 1240, such as a mains electricity supply, a vehicle battery, a power generator, fuel cell or the like, to an electric load 1340.

It will be appreciated, that such an inductive power transfer system 1000 may significantly reduce power losses associated with prior art power transfer systems. During the standby mode little or no power may be drawn from the power supply 1240. The inductive power outlet 1200 may be configured to switch to transmission mode only in the presence of a suitable inductive power receiver 1300. Furthermore, the system 1000 may be operable to revert to standby mode when no power need be transferred, for example when the inductive power receiver 1300 is removed or the electric load 1340 requires no further power. Thus power is only drawn by the system 1000 when actually required. Various activation and termination protocols may be used with the system, such as described hereinafter.

Referring now to the flowchart of FIG. 10B, the inductive power transfer system 1000 may switch between standby mode and transmission mode by a number of pathways. When in standby mode, the inductive power outlet 1200 or the inductive power receiver 1300 may be configured to wait for an activation signal. If such an activation signal is received, the system 1000 may switch to transmission mode. Where appropriate, activation of the system 1000 may involve an initial trigger signal activating the inductive power outlet 1200 and an authentication process confirming the presence of a suitable inductive power receiver 1300.

When in transmission mode, the inductive power transfer system 1000 may be configured to periodically transfer signals between the inductive power receiver 1300 and the inductive power outlet 1200, such as described hereinabove in relation to FIG. 5, for example.

As detailed below, various transmission signals may be used with the system, for example, instructions may be sent from the inductive power receiver 1300 to the inductive power outlet 1200 to increase power by a certain interval, to decrease power by a certain interval, to maintain the same power, to terminate power transfer or the like. Where no such transmission signals are received, the inductive power outlet 1200 may be configured to stop driving the primary inductor 1220 and to revert to the standby mode.

In particular, the inductive power transfer system 1000 may be configured to revert to standby mode when a termination signal is transferred between the inductive power receiver 1300 and the inductive power outlet 1200. Where appropriate, the inductive power receiver 1300 may be configured to send a termination signal to the inductive power outlet 1200 when the electric load 1340 no longer requires power. For example, where the electric load 1340 is an electrochemical cell being charged by an inductive charger, say, a termination signal may be generated when the electrical cell is fully charged.

It will be appreciated that an inductive power transfer system such as disclosed herein may reduce significantly the amount of power drawn by dormant power adaptors, chargers and the like.

Referring back to FIG. 10A, the system 1000 may include a trigger mechanism 1400 and a signal transfer mechanism 1120. The trigger mechanism 1400 may be used while the inductive power transfer system 1000 is in the standby mode, to provide an initial trigger to generate an activation signal such that the inductive power transfer system 1000 switches to transmission mode. The signal transfer mechanism 1120 may provide a channel for the inductive power receiver 1300 to send instruction signals, such as identification signals, authentication signals, transmission signals, termination signals or the like to the inductive power outlet 1200. Furthermore, the signal transfer mechanism 1120 may provide a channel for data transfer signals for communication of information from the inductive power receiver 1300 to the inductive power outlet 1200.

The inductive power outlet 1200 of the inductive power transfer system 1000 includes a primary inductor 1220 such as a primary inductive coil, for example, connectable to the power supply 1240 via a driver 1230. The driver 1230 provides the electronics necessary for supplying an oscillating voltage to the inductive coil 1220. The inductive power receiver 1300 typically includes a secondary inductor 1320, such as a secondary inductive coil, a regulator 1330 and an electrical load 1340.

The secondary inductive coil 1320 is configured to inductively couple with the primary inductive coil 1220 of the inductive power outlet 1200. Where required, the regulator 1330 may include a rectifier to convert alternating current induced across the secondary coil 1320 to a direct current signal for supplying the electrical load 1340. A rectifier 1330 may be necessary, for example, where the electrical load 1340 comprises an electrochemical cell to be charged.

The trigger mechanism 1400 may control the connection between the power supply 1240 and the inductive power outlet 1200. The trigger mechanism 1400 may include a circuit breaker 1420 and a trigger sensor1440. Optionally, trigger mechanism 1400 may further include an auxiliary power source 1460 for providing power when the inductive power outlet 1200 is disconnected from its power supply 1240. Various auxiliary power sources 1460 may be used in embodiments of the trigger mechanism 1400 such as electrochemical cells, capacitors and the like, which may be configured to store energy while the inductive power outlet 1200 is connected to the power supply 1240 for use when the inductive power outlet 1200 is disconnected. Still other auxiliary power sources may include electricity generating elements such as solar cells, piezoelectric elements, dynamos or the like.

The circuit breaker 1420 may be configured to receive a disabling signal from the trigger and in response to provide an electrical connection between the power supply 1240 and the inductive power outlet 1200. Various circuit breakers 1420 may be used to disconnect the inductive power outlet 1200 from the power supply 1240 as suit requirements. For example, an electronic switch may be provided such as a Metal-Oxide Semiconductor Field-Effect Transistor (MOSFET) or the like the gate terminal of which may be configured to receive the electrical signals sent by the trigger sensor 1440. Other circuit breakers may include for example, a single pole switch, a double pole switch, a throw switch or the like.

The trigger sensor 1440 is configured to detect a release signal indicating the proximity of a possible inductive power receiver 1300. The trigger 1440 may be further configured to disable the circuit breaker 1420 when the release signal is detected. Optionally, an activator 1480 incorporated into the inductive power receiver 1300 is configured to produce the release signal which is detectable by the trigger 1440.

In one embodiment the trigger mechanism 1400 may include a magnetic detector such as a Hall Effect switch, reed switch or the like. The magnetic switch may be configured to detect an increase in magnetic field as a result of the approach of an activating magnetic element associated with the inductive power receiver 1300. It will be appreciated that a Hall Effect switch may be configured to detect the approach of an alignment magnet associated with the inductive power receiver 1300 which further functions as the activating magnetic element 1480 for the trigger mechanism 1400. It will be further appreciated that other magnetic switches may be used in other embodiments of the trigger mechanism as will occur to the skilled practitioner. Still other embodiments of the trigger mechanism may be used, for example, as described in the applicants co-pending patent application PCT/IL2010/001013 which is incorporated herein by reference.

The signal transfer system 1120 may include an inductive feedback channel 7120 such as described hereinabove in relation to FIG. 8. The regulator 1330 of the inductive power receiver may be in communication with a transmission circuit 1122 including a signal generator 1123, a switching unit 1125 and an ancillary load 1340. The signal generator 1123 may be a modulator 7123 such as described in FIG. 8. The switching unit 1125 may be a MOSFET 7125 such as described in FIG. 8. Variously, the ancillary load 1126 may be an electrical resistor 7126 such as described in FIG. 8, although other electrical elements such as capacitors, inductors and the like may alternatively or additionally serve as the ancillary load 1126. The transmission circuit 1122 may thus modulate the power drawn by the secondary inductor 1320. The modulated power may be detected by a signal detector 1124 associated with the inductive power outlet 1200.

The inductive power outlet 1200 includes a signal detector 1124 comprising a peak detector 1128 and a processor 1129. The peak detector 1128 may be configured to detect peaks in primary voltage across the primary inductor or primary current supplied to the primary inductor. Thus, the peak detector 1128 may be able to detect when the ancillary load is connected to the secondary inductor 1320. The processor 1129, such as the demodulator 7129 described above in relation to FIG. 8, may be provided to determine the frequency of peak pulses. Such an ancillary load may be selected from an ancillary resistor, an ancillary capacitor, an ancillary inductor or the like.

The signal transfer system 1120 may be used to transmit instruction signals such as identification signals, authentication signals, transmission signals, termination signals or the like, as well as digital communications to the inductive power outlet 1200 in the form of peak pulses having characteristic frequencies.

The regulator 1330 of the inductive power receiver 1300, which may include a controller, rectifier, capacitors, microcontroller, voltage monitor or the like, is in communication with the transmission circuit 1122.

The regulator 1330 may be operable to monitor induced secondary voltage across the secondary inductor 1320 and to compare the induced voltage with reference values. By comparing the secondary voltage with threshold values, the regulator 1330 may determine whether the secondary voltage lies within a permissible range of values. Accordingly, instruction signals may be selected by the regulator 1330 and generated by the transmission circuit 1122 instructing the inductive power outlet 1200 to adjust the induced voltage across the secondary inductor 1320.

It will be appreciated that in standby mode no voltage is induced across the secondary inductor 1320. As outlined in greater detail below, in standby mode, the regulator 1320 and transmission circuit 1122 may be further operable to respond to an activation voltage pulse induced across secondary inductor 1320 by generating an identification instruction signal (ID signal). The ID signal may be detected by the inductive power outlet 1200 thereby confirming the presence of the inductive power receiver 1300 and optionally its required operating parameters.

### Extended Signaling Support:

The signal transfer system may be used to transmit instruction signals such as identification signals, authentication signals, transmission signals, termination signals or the like, as well as digital communications to the wireless power outlet in the form of peak pulses having characteristic frequencies

The requirements detailed hereinafter are applicable to an advanced capability (AC) power receiver coil supporting operation with extended signaling. Optionally, various signaling extensions may be used.

An AC power receiver coil supporting the defined signaling extensions may support all requirements that are associated with that signaling extension option.

Where appropriate, all AC power receiver coil may advertise their extended signaling support as part of the AC message structure.

### Modulation Scheme and Byte Framing

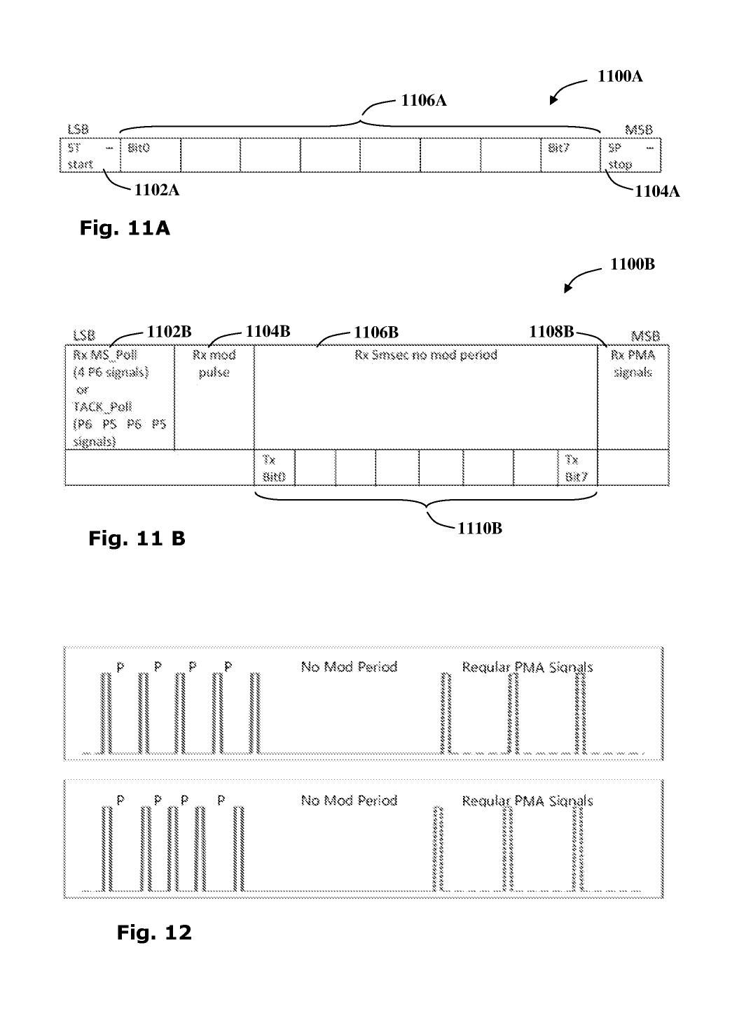

Reference is now made to FIG. 11A showing a general message byte structure 1100A of a power receiver coil extended signaling message.

The general message byte structure 1100A of the extended signaling messages may include a start bit 1102A, a stop bit 1104A and a byte 1106A of 8 bits long surrounded with the leading start bit 1102A and the stop bit 1104A, closing the message section.

It will be appreciated that communications, or messages, may be constructed from multiple bits. Strings of bits may represent bytes of information. Where appropriate, a byte may be characterized as a string of 10 bits: BitST, Bit0, Bit1, Bit2, Bit3, Bit4, Bit5, Bit6, Bit7 and BitSP. The initial bit BitST may be a START bit used to indicate that the following string of eight bits represent a byte and BitSP may be a STOP bit used to indicate that the byte has terminated.

According to a particular example BitST 1102A may be set to logic state 0 to indicate initiation of a byte of data and BitSP 1104A may be set to logic state 1 to indicate the byte's termination

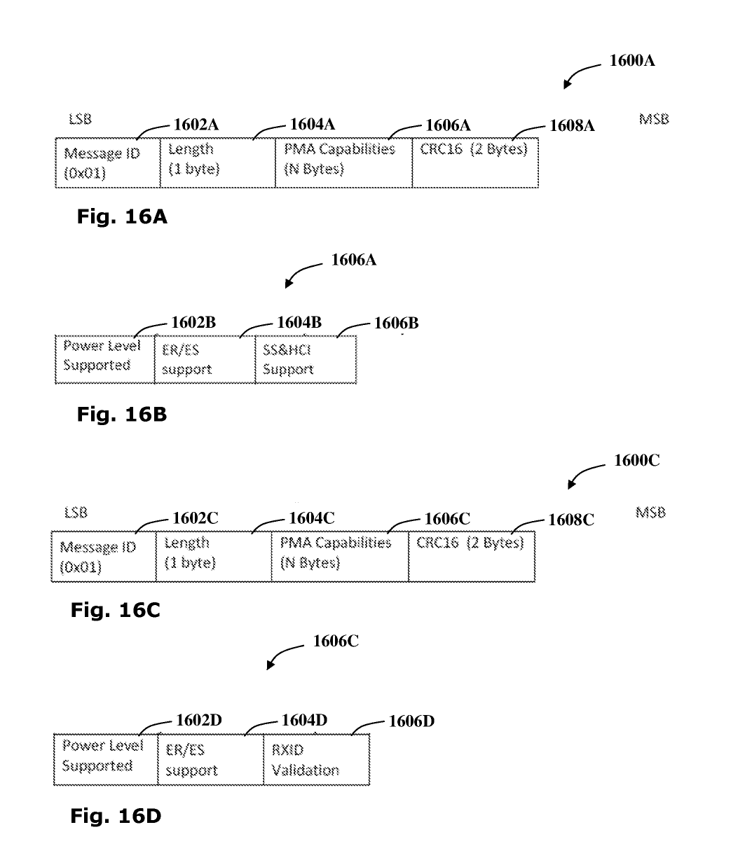

It is noted that the message bytes belonging to the same message may not be sent continually, but the maximal gap between BitST 1102A of a byte to the next BitST 1102A of another byte in the message shall not exceed tₛₜ₂ₛₜ (as defined in table of FIG. 16).

As described herein, various data transfer protocols may be used to transfer such message bytes via either inband communication channels such as the PMA protocol for example, or via out of band communication channels such as Bluetooth, WiFi, radio transmission, near field communication, ultrasound, audio transmissions, say at frequencies of 18 kilohertz to 22 kilohertz for example, and the like as well as combinations thereof.

It is further noted the logic ‘0’ may be set, according to one example, by the PMA MsgBit (P5) signal while logic ‘1’ may be coded using either one of the following signals: PMA Dec, PMA Inc, PMA NoCh or PMA_EOC signal.

Where appropriate, data messages from power receiver coil are sent after the power receiver coil sends an MSGS (message start) signal. The MSGS signal may be composed of 4 PMA signals are follows: P6 P6 P5 P5.

Ack messages from power receiver coil are sent after the power receiver coil sends a RACK (Receiver Acknowledge) signal. The RACK signal is composed of 4 PMA signals as follows: P6 P5 P5 P6.

Reference is now made to FIG. 11B showing a power transmitter coil byte transmission format 1100B of a power transmitter coil extended signaling message.

The transmission format 1100B of the power transmitter coil extended signaling message may include a message type field 1102B, a power receiver coil mod pulse field 1104B, a no mod period field 1106B, a power receiver coil PMA signals field 1108B and a byte field 1110B of 8 bits long from Bit0 to Bit7 of the message section.

The extended signaling modulation and byte framing for a power transmitter coil, the extended signaling messages and Ack are sent a byte at a time after explicit polling request from a power receiver coil.

A power receiver coil may be initiating a polling request, optionally by sending an MS-Poll (message poll) signal (coded as 4 consecutive P6 physical signal as detailed hereinabove) or TACK_Poll signal (coded as a P6 P5 P6 P5 signals pattern) within the message type field 1102B. The power receiver coil then, may further be initiating a mod pulse followed by 5 msec of no-mod period as described in the associated field 1104B. The power transmitter coil may be responding by sending a byte of data (message data or Ack according to poll type, as defined by the message type field 1102B) in the byte field 1110B. Once the 5 msec period is completed the power receiver coil may be resuming standard PMA signaling, with the transmission flow as illustrated in FIG. 11A. The graphical representation of the transmission sequence of the power transmitter coil is shown in FIG. 12, with a message based upon extended signaling attributes, separated by a ‘no mod period’ (of 5 msec) and followed by continuous regular signals.

It is noted that the modulation used for power transmitter coil transmission may be frequency modulated and bits using Manchester coding, where ‘0’ bits are coded as high frequency on the first half of the symbol and lower frequency on the second half, while ‘1’ bits are coded with low frequency on the first half followed by higher frequency of the second half.

It is further noted that the power receiver coil may be configured to decode power transmitter coil frequency modulated signals with frequency gap of 4.5 kilohertz-10.5 kilohertz and bit duration of 450-550 usec and duty cycle of 45-55%.

Where required, radio frequency transmission may used for communication between the wireless power transmitter and wireless power receiver. Accordingly, the receiver and the transmitter may be provided with transceivers for communicating at a frequency band of around 2.4 gigahertz. It is particularly noted that in some systems communication at frequencies of between 2.4 gigahertz to 2.485 gigahertz or the like may be used.

Alternatively, ultrasonic or audible signals may be used to encode bits using sonic waves for example with frequencies between 18 kilohertz and 22 kilohertz used where appropriate although frequencies below 18 kilohertz or higher than 22 kilohertz may be preferred as suit requirements.

According to particular embodiments, sonic signals of frequencies between about 19 kilohertz and 21 kilohertz may be used for transmitting signals from the transmitter to the receiver and frequencies about 18 kilohertz may be used for transmitting signals from the receiver to the transmitter. However the invention is not limited to any particular range as other frequency bands may be preferred as appropriate.

Digital signal processing may be used to evaluate the signals, accordingly, analog-digital-converters may be provided to sample communication signals and digital-analog-converters may be provided to produce an appropriate output. Various digital signal processing methods may be used to analyze received signals such as, in a non limiting manner, using of the Goertzel algorithm, the Bilinear transform, Discrete Fourier transform, Discrete-time Fourier transform, Filter design, LTI system theory, Minimum phase, Transfer function, Z-transform, s-plane or the like.

### Message Format:

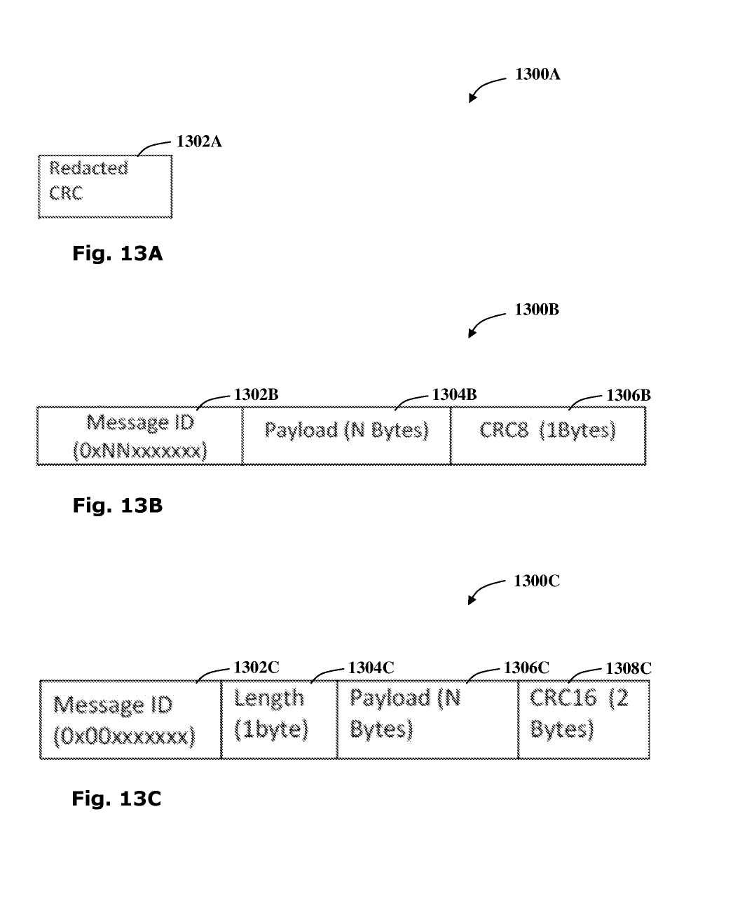

Reference is now made to FIGS. 13A-C illustrating various message formats, including control message format and various data message formats.

The control message format of the extended communication signaling is illustrated in FIG. 13A, while data messages may use various format types, such as:
RxID message, as detailed hereinafter
Short messages having a length of 3-5 bytes, as described in FIG. 13B.
Long messages having a variable length of up to 128 byte, as described in FIG. 13C.

Where appropriate, the RXID message structure may comprise a string of bytes such as described herein. The byte string may comprise a preamble byte, a message ID byte, the MACID (identification string), which may itself comprise a string of six bytes, and a two byte cyclic redundancy check (CRC). Optionally, in a particular embodiment, the Preamble byte is fixed to 0x00 and the Message ID byte is set to 0xAA. It will be appreciated that other messages may be defined to suit requirements. Optionally, where required, a Certification-Version byte may be included possibly between the Message ID byte and the MACID field.

Referring to FIG. 13A, illustrating format 1300A of a control message that may be used in bi-directional signaling only. Where appropriate, acknowledge messages provide indication for the last message that was received correctly. The format 1300A, may optionally include a redacted CRC field 1302A.

It is noted that the redacted CRC byte may contain the XOR of the two byte CRC16 of the last correctly received acknowledged message.

Referring to FIG. 13B, illustrating the general format 1300B for short data messages, which may be used for bi-directional messaging only.

The general format 1300B for short data messages of the extended signaling may include a Message ID field 1302B, a Payload field of N bytes 1304B and CRC16 field of 2 bytes long 1306B.

For short messages the two MSBs of message ID are indicating the number of payload bytes in the message and may be set to 1, 2 or 3. Additionally, there may be 64 possible different short message IDs for each of these length settings.

It is noted that Message IDs 0xNN111000-0xNN111111 are reserved for short unacknowledged vendor specific messages, while all other IDs are reserved and may not be used by vendors for proprietary messages. Where appropriate, vendors utilizing vendor specific messages may need testing of compatibility verification of the remote side to their proprietary message protocol. Further, if the receiving side of a vendor specific message is not compatible with the transmitting side or does not support vendor specific messages, such messages may be discarded.

It is further noted that short messages may not be acknowledged by the recipient and as such, referred to as unacknowledged messages.

Referring to FIG. 13C, illustrating the general format 1300C for long data messages, which may be used for unidirectional and bi-directional messaging.

For long messages the 2 MSBs of message ID may be set to ‘00’. There are 64 different possible long message IDs.

It is noted that Message IDs 0x37-0x3F may be reserved for vendor specific acknowledged long messages, while all other IDs may be reserved and may not be used by vendors for proprietary messages.

It is further noted that for power transmitter coil and power receiver coil supporting bi-directional communication, long messages may be acknowledged by the recipient, referred hereinafter as acknowledged messages. Long messages cmayan also be used in unidirectional communication from power receiver coil to power transmitter coil, but in this case they may be unacknowledged.

### Bi-Directional Signaling Control Flow:

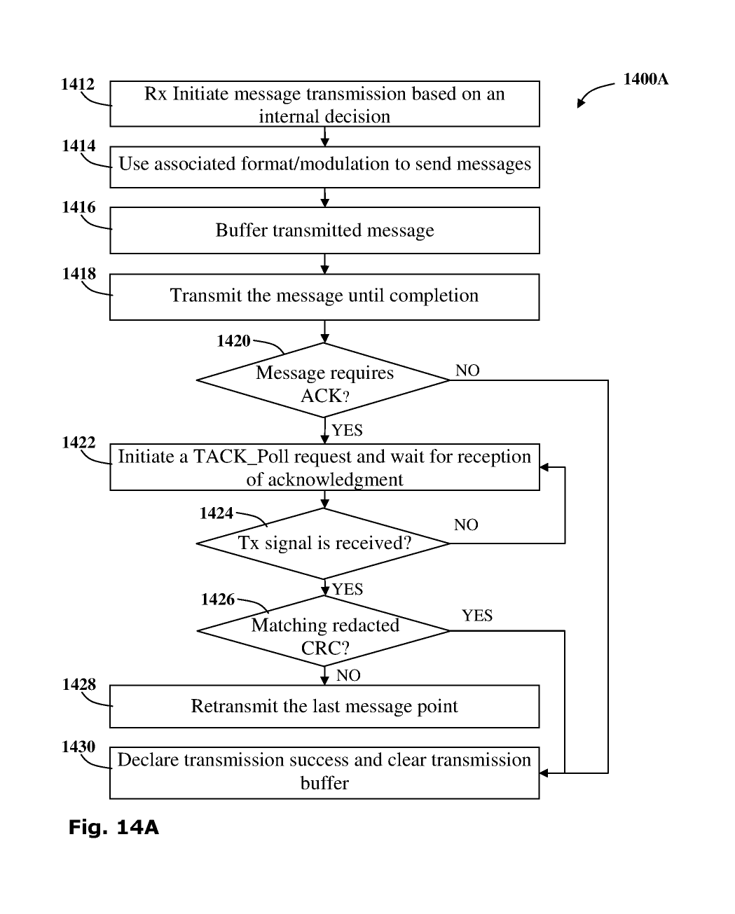

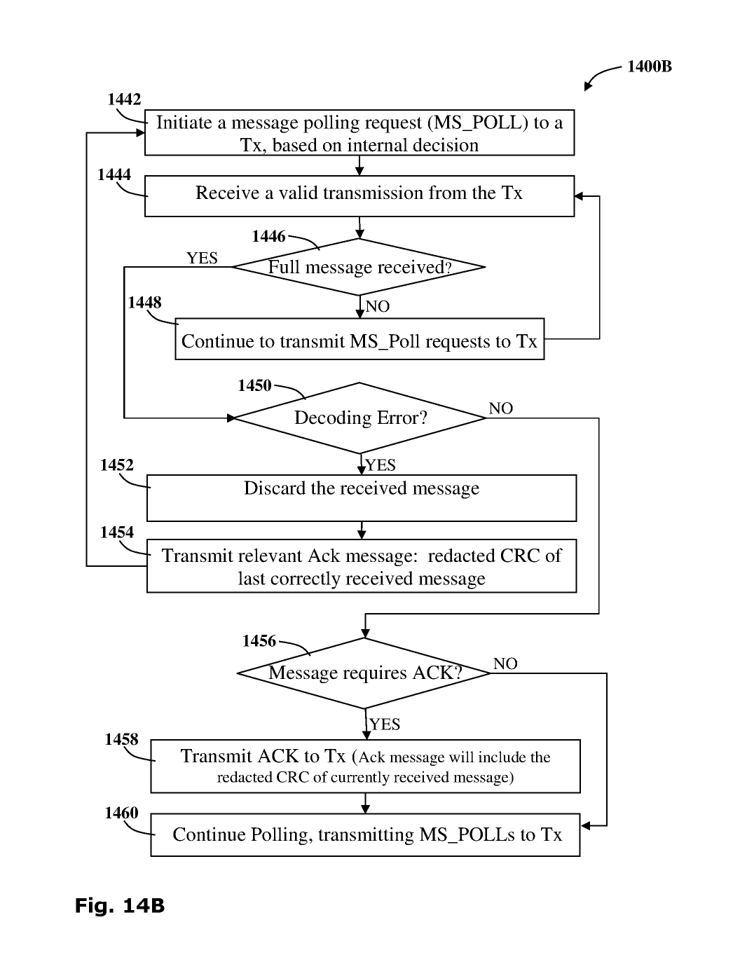

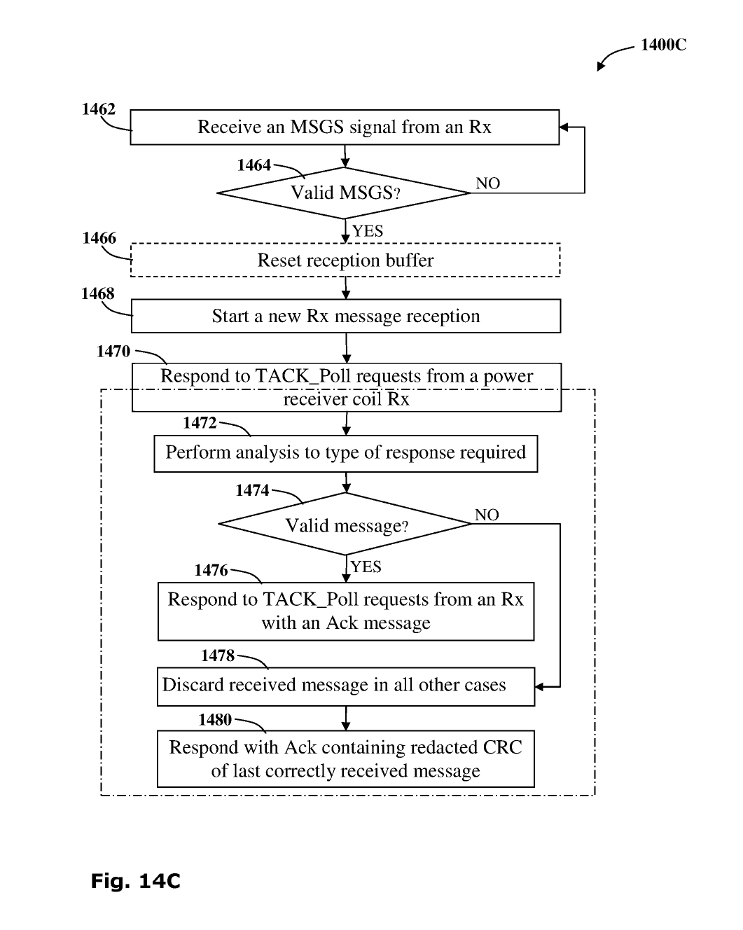

Reference is now made to the flowcharts of FIGS. 14A-D, which schematically represent selected actions, providing a possible illustration for bi-directional signaling control flow, controlling communication between a power receiver coil and a power transmitter coil and vice versa.

The flowchart of FIG. 14A illustrates a possible message transmission communication initiated by a power receiver coil; the flowchart of FIG. 14B illustrates a possible message reception communication of a power receiver coil; flowchart of FIG. 14C illustrates a possible message reception communication of by a power transmitter coil; and flowchart of FIG. 14D illustrates a possible message transmission communication initiated by a power transmitter coil.

Referring now to the flowchart of FIG. 14A, selected activities are presented mainly indicating activities on the power receiver coil side directed for a possible message transmission communication 1400A. The message transmission 1400A may optionally include initiating a possible message transmission by the power receiver coil, based upon internal decision—step 1412; applying an associated format and modulation for use with messages sent, as described hereinabove—step 1414 (selecting appropriate message format, FM modulation and the like), including sending of MSGS signal before starting the first byte of any new data message. MSGS messages may be sent with a minimal gap of t_{msggap} (as defined in table of FIG. 16); buffering the transmitted message until it is correctly acknowledged, if acknowledgment is required—step 1416; and transmitting the message until completion—step 1418; thereafter, testing if the associated message requires acknowledgment—step 1420.

If the associated message requires acknowledgment, then initiating a polling request may be triggered, by issuing a TACK_Poll request, and waiting for reception of acknowledgment—step 1422; thereafter, testing signal received from power transmitter, if received—step 1424. If no signal is received on the power receiver side, then returning to step 1422 for submitting an additional polling request; once, the associated power transmitter signal is received, then testing the signal for matching of redacted CRC—step 1426, may be performed; if the received byte from the power transmitter is not matching the redacted CRC of the message or not receiving a power transmitter signal after a retry of TACK_Poll, then the power receiver may apply retransmitting of the last message—step 1428; If the received byte is matching the required redacted CRC of the message from the power transmitter, then the declaring this as transmission success, clearing the transmission buffer—step 1430.

It is noted that a power receiver coil may not transmit an acknowledged message while it is actively receiving a message from a power transmitter coil, but where appropriate, the power receiver coil may transmit unacknowledged messages between polls for reception of ongoing message from.

Referring now to the flowchart of FIG. 14B, selected activities are presented indicating activities on the power receiver coil side, directed for a possible message reception communication 1400B.

Power receiver coil transmissions may be generated in response to power receiver coil MS_Poll requests, if both power receiver coil and power transmitter coil support bi-directional signaling. Where appropriate, the power receiver coil is periodically polling the power receiver transmitter for messages.

Optionally, the AC power receiver coil may decide the exact timing for polling of the power transmitter coil. Additionally or alternatively, the power transmitter coil may provide polling period recommendations to the power receiver coil via its polling period message. Such message may be delivered during the Identification phase or during power transfer phase.

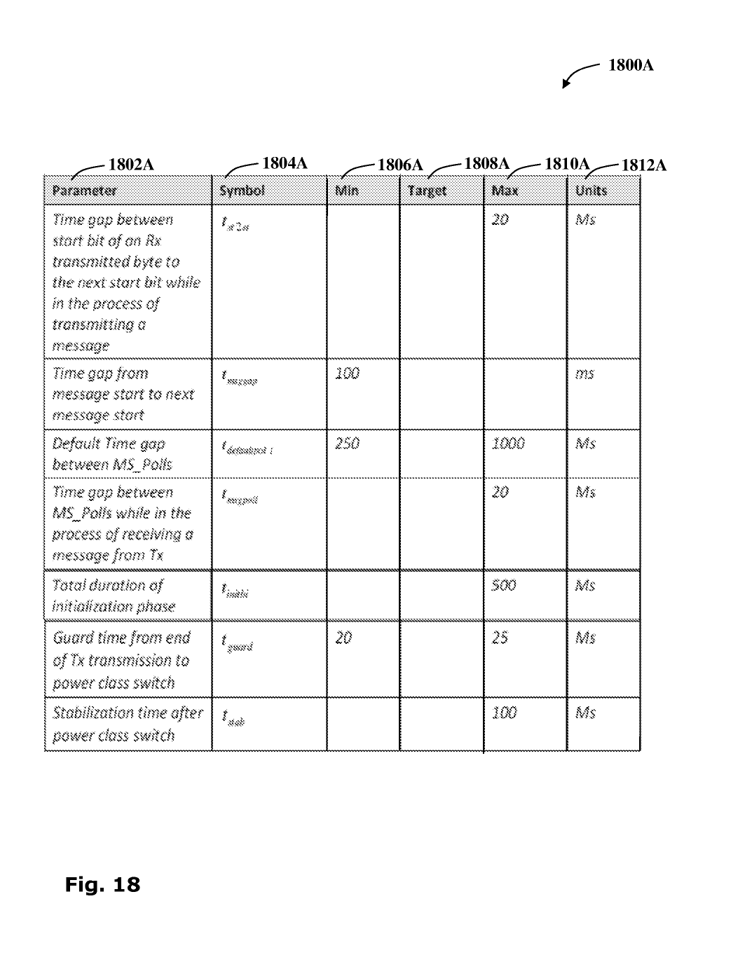

It is noted that if a polling period is provided, the power receiver coil may comply with it and perform the polling at a rate that would not be lower than the requested polling period. Further, if such a polling period is not provided the power receiver coil may use a default period of t_{defaultpoll} (as defined in table of FIG. 18).

It is further noted that the power receiver coil may not initiate MS_Poll requests while in the middle of power receiver coil message transmission. Further, if during MS_Poll period, the AC receives valid transmissions from the power transmitter coil, it may continue to MS_Poll the power transmitter coil until the full message is transferred. The time interval between two polls (as measured from start of MS_Poll to start of next MS_Poll in this case should not exceed t_{msgpoll} (as defined in table of FIG. 16).

The method 1400B may optionally include initiating a possible message polling request to a power transmitter coil, based upon internal decision, as described hereinabove—step 1442; receiving a valid transmission from the associated power transmitter coil during the MS_Poll period—step 1444; testing if message has transferred and received in full, on the power receiver coil—step 1446, in which the message length is determined based on message length byte and message type; and further transmitting MS_Poll requests to the power transmitter coil—step 1448, continually, until the full message is transferred and received by the power receiver coil. Once, the full message is received, testing for decoding errors—step 1450 is performed; and in case of decoding errors, discarding the received message—step 1452; combined with transmitting the relevant Acknowledged message of redacted CRC of last correctly received message—step 1454, immediately without waiting for full reception of all message bytes as indicated in the message length.

Once the full message is received (length is determined based on message length byte and message type) with no decoding errors, the method is further testing if message requires Acknowledgement—step 1456; transmitting an acknowledge if so required by the power transmitter coil—step 1458, in which the acknowledge message may include the redacted CRC of the currently received message. Optionally, the acknowledge message transmission may include the transmission of RACK signal followed by the relevant redacted CRC byte.

Further, if an acknowledged message is transmitted accordingly (step 1458) or no acknowledge is required (step 1456), the method may continually be transmitting MS_Polls to support bi-directional communication—step 1460.

It is noted that decoding errors possibly refer to various situations such as when no signal is received on the side during one of the MS_POLL periods while a power transmitter coil acknowledged message reception. Additionally or alternatively, a non-valid byte received from the power transmitter coil may reflect another possible decoding error.

Referring now to the flowchart of FIG. 14C, selected activities are presented indicating activities on the power transmitter coil side, directed for a possible message reception communication 1400C.

A new message reception on the power transmitter coil side may start only after receiving an MSGS signal from the power receiver coil—step 1462; validating the received MSGS signals—step 1464; otherwise, steps 1462 and 1464 are repeated, until receiving valid MSGS signals; further, resetting reception buffer—step 1466, if power transmitter coil was in the process of receiving another message; and starting a new message reception—step 1468.

It is noted that the power transmitter coil may decode any messages sent from a wireless power receiver coil as described hereinabove.

Once a new message reception session started, responding to TACK_Poll requests from a power receiver coil—step 1470, may refer to different message validity state requires performing analysis to type of response to be provided—step 1472; testing validity of the message—step 1474; and respond with an acknowledge message including the redacted CRC of the received message—step 1476, if the TACK_Poll request is received immediately after the reception of the last byte of an acknowledged message, that message has been valid, and no MS_Polls signals were received during its transmission; otherwise, discarding the received message—step 1478; and responding with an acknowledged message containing the redacted CRC of the last correctly received message—step 1480.

It is noted that discarding a received message is referred to in conditions of CRC error, TACK received prematurely or late, MS_Poll received during power receiver coil message reception.

Referring to the flowchart of FIG. 14D, representing possible selected actions of a method for message transmission 1400D by the wireless power transmitter.

The message transmission 1400D may optionally include buffering repeatedly any message for transmission—step 1482; until receiving MS_Poll requests from—step 1484; and sending the buffered bytes of the power transmitter coil message—step 1486 to the, continually, testing the power transmitter coil message bytes on each of the poll periods following the MS_Poll requests from until message transmission is completed—step 1488; receiving an acknowledged message from the power receiver coil after the last byte transmission of the message—step 1490; and if the received acknowledge is matching the message from power receiver coil after the last byte transmission of a message (RACK signal followed by the message redacted CRC), then it will consider message as acknowledged, removing message from buffer—step 1496; and further completing the transmission of the acknowledged state—step 1498; otherwise, aborting the transmission—step 1494, if the acknowledged received does not match the redacted CRC of the transmitted message or if the acknowledged message was received prematurely, considering the transmission as failed, but keeping the power transmitter coil message in buffer awaiting new transmission opportunity—step 1494.

It is noted that if the power transmitter coil completed transmission of an acknowledged message but received an additional MS_Poll message without receiving a RACK signal from the power receiver coil, it will not respond to the MS_Poll and will not modulate the power carrier during that poll period. Further, the message will be considered as a failed transmission, reattempting transmission on next received MS_Poll.

It is further noted that if the power transmitter coil receives an MS_Poll but has no message to transmit then it will not transmit any data and will not modulate the carrier frequency.

### Directional Extended Signaling Support:

As described hereinabove, the extended signaling may split into 3 categories of Unidirectional, Bi-directional and Continuous bi-directional. The simplest form supports unidirectional traffic from a power receiver coil to a power transmitter coil and may provide the required signaling for some of the extended functions; the second form relates to bi-directional traffic capability between power receiver coil and power transmitter coil during the identification phase and may allow to support of the functional extensions such as increased power support; and the third form defines continuous bi-directional traffic while in power transfer phase.

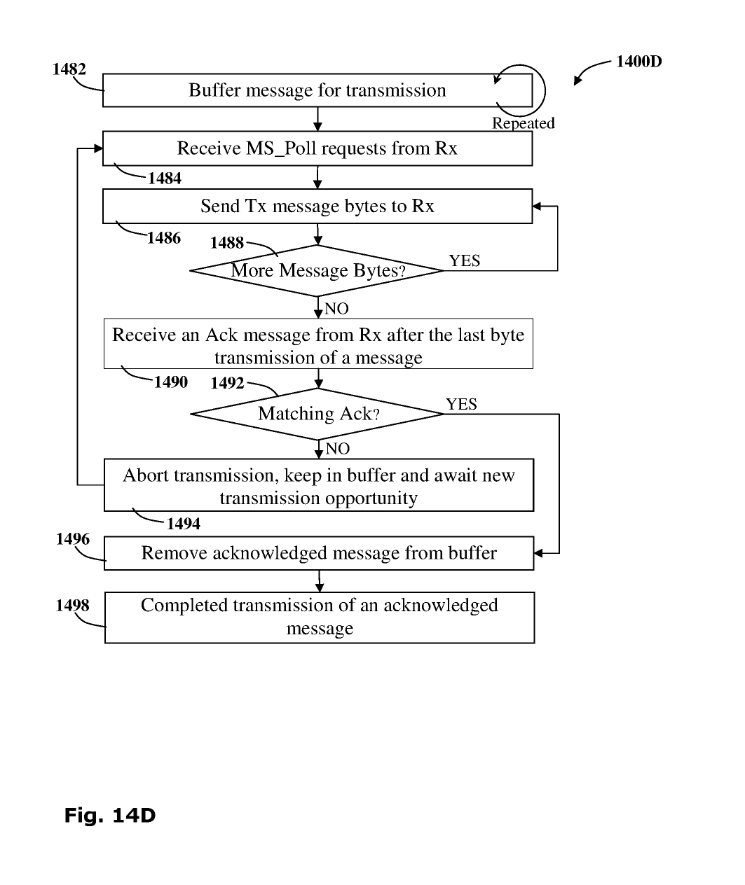

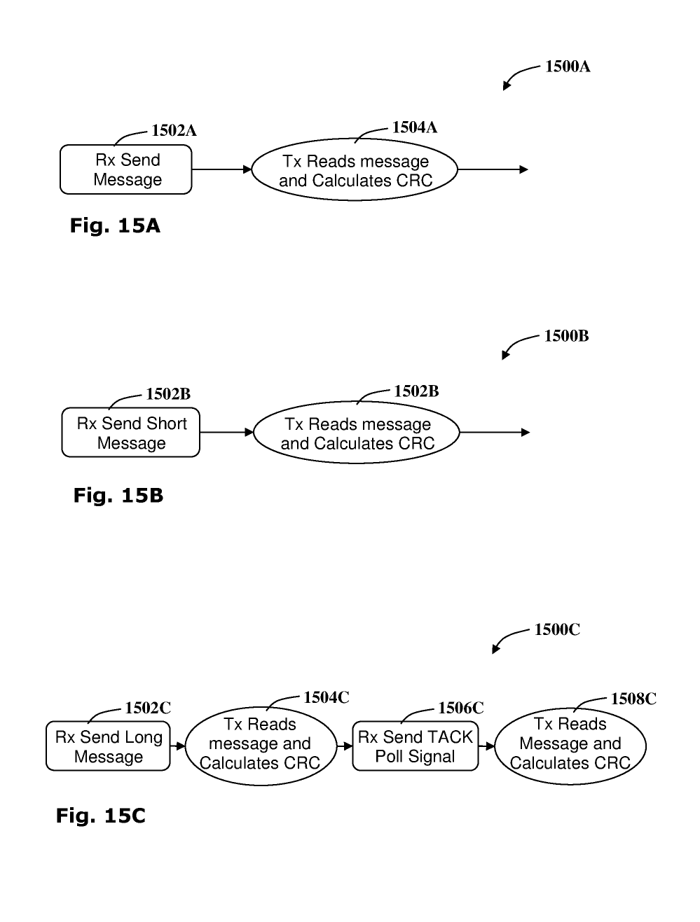

Reference is now made to the flowcharts of FIGS. 15A-C, which schematically represent selected actions providing support for directional extended signaling, controlling communication between a power receiver coil and a power transmitter coil and vice versa.

Referring to the flowchart of FIG. 15A representing selected actions illustrating a possible message transmission communication 1500A initiated by a power receiver coil, providing uni-directional extended signaling support. The message transmission communication 1500A may include the steps of: a power receiver coil sending a message—step 1502A; and a power transmitter coil reading the message and calculating a CRC value for validation and error management purposes—step 1504A.

It is noted that an advanced capability (AC) power receiver coil that declares support for uni-directional signaling is capable of transmitting data messages beyond the RXID message. Where appropriate, the transmission of these messages may be performed in the identification phase or power transfer phase.

Further, an AC power receiver coil may use the extended signaling only upon detecting a power transmitter coil advertising during digital ping phase. If no such advertising is detected, the AC power receiver coil may be discarding any usage of the extended signaling functionality.

Referring to the flowchart of FIG. 15B representing selected actions illustrating a possible message transmission communication 1500B initiated by a power receiver coil, providing bi-directional extended signaling support. The message transmission communication 1500B may include the steps of: a power receiver coil sending a short message—step 1502B; and a power transmitter coil reading the message and calculating a CRC value for validation and error management purposes—step 1504B.

It is noted that an AC power receiver coil declaring support for bi-directional extended signaling is configured to supporting the uni-directional extended signaling transmission as defined hereinabove (FIG. 15A). Additionally or alternatively, such configuration of an AC power receiver coil enables decoding any message sent from a power transmitter coil during the digital ping and identification phases.

Where appropriate, the AC power receiver coil is operable to decoding the power transmitter coil advertising message sent during the digital ping period (as described hereinabove of message format specification). The AC power receiver coil may further be operable to monitoring the power transmitter coil bi-directional signaling capability bit that may be included in power transmitter coil advertising.

Where appropriate, an AC power receiver coil detecting a power transmitter coil configuration with bi-directional communication capability may be transmitting all required identification messages, and initiating a TACK_Poll request after each acknowledged message, enabling power transmitter coil to acknowledge reception (as detailed in FIGS. 14A-D, procedures for power receiver coil transmission).

Once sending all messages is completed with appropriate acknowledging, then initiating MS_Poll request continually, until detecting two consecutive no response signals from power transmitter coil.

Where appropriate, if the AC power receiver coil is receiving any of the power transmitter coil messages with errors, reseting connection may be triggered with the power transmitter coil by sending an EOC message with a 0xB0 cause/sleep (‘Communication Error’ and sleep of 2 sec) followed by EOC signals. Further, the power transmitter coil may be shutting off the power carrier and restarting digital ping phase.

Where appropriate, if the AC power receiver coil is completing the bi-directional messaging during the identification phase, then moving to power transfer phase is within t_{initbi} (as defined in table of FIG. 16) from the identification phase start. Additionally or alternatively, the same functionality may be applied even if the had not been able to completing the transmission of all its buffered messages.

Referring to the flowchart of FIG. 15C representing selected actions illustrating a possible message transmission communication 1500C initiating by a power receiver coil and providing continuous bi-directional extended signaling support. The message transmission communication 1500B may include the steps of: a power receiver coil sending a long message—step 1502C; a power transmitter coil reading the message and calculating a CRC value for validation and error management purposes—step 1504C; a power transmitter coil sending TACK_Poll signal—step 1506C; and a power transmitter coil reading the message and calculating a CRC value for validation and error management purposes—step 1508C.

It is noted that an AC power receiver coil declaring support for bi-directional extended signaling is configured to supporting uni-directional extended signaling transmission as defined hereinabove. Additionally, such AC power receiver coil may be configured to decoding any messages sent from a power transmitter coil during digital ping and Identification phases.

Where appropriate, the AC power receiver coil may be operable to decoding the power transmitter coil advertising message sent during the digital ping period (as described hereinabove of message format power transmitter coil specification). Additionally or alternatively, the AC power receiver coil may further be operable to monitoring the power transmitter coil bi-directional signaling capability bit (see power transmitter coil spec for details) included in power transmitter coil advertising.

Where appropriate, an AC power receiver coil detecting a power transmitter coil with bi-directional communication capability may be transmitting all identification messages it requires, initiating a TACK_Poll request after each acknowledged message, thus enabling a power transmitter coil to acknowledge reception (see detailed procedures for transmission).

Once sending all messages is completed with appropriate acknowledging, then initiating MS_Poll request continually, until detecting two consecutive no response signals from power transmitter coil power transmitter coil.

Where appropriate, if the AC power receiver coil is receiving any of the power transmitter coil messages with errors, resetting connection may be triggered with the power transmitter coil by sending an EOC message with a 0xB0 cause/sleep (‘Communication Error’ and sleep of 2 sec) followed EOC signals. Further, the power transmitter coil may be shutting off the power carrier and restarting digital ping phase.

### Advanced Capabilities Reporting:

Reference is now made to FIGS. 16A-D, illustrating various message structures of advanced capabilities reporting supported by the extended signaling communication protocol of the current invention. FIGS. 16A-B refer to advanced capabilities reporting message structure of a power receiver coil, while FIGS. 16C-D refer to advanced capabilities reporting message structure of a power transmitter coil.

Referring to FIG. 16A, illustrating a power receiver coil Advance Capabilities Reporting (RACR) message structure 1600A. The message structure 1600A may include message ID field 1602A, Length field 1604A, Capabilities field 1606A and CRC16 field 1608A.

It is noted that an AC power receiver may be transmitting an Advanced Capabilities Reporting (RACR) message during the identification period after transmitting an RXID message.

Where appropriate, the Message ID byte field 1602A may be set to 0x01 for the RACR message and the Length field 1604A, 1 byte long, may define the number of bytes that follow, optionally excluding the CRC16 bytes. Further, the Capabilities field 1606A, may have a variable length as may be indicated by the Length field. The Capabilities field 1606A is further shown in the structure detailed in FIG. 16B. The RACR message is terminated with CRC16 field of 2 bytes, optionally with 0x1201 generator Polynomial.

Referring to FIG. 16B, illustrating the Capabilities field structure 1606A of a power receiver coil Advance Capabilities Reporting (RACR) message structure. The Capabilities field structure 1606A may include Power Level Supported field 1602B, ER/ES (Extended Range and Extended Signaling) Support field 1604B and SS&HCI Support field 1606B.

The Power Level Supported field 1602B indicates the power classes the Extended Power (EP) power receiver coil may support. The possible bits of this field may be coded as follows:
0—Support for power class 0 (baseline 5 W)
1—Support for power class 1 (10 W)
2—Support for power class 2 (15 W)
3—Support for power class 3 (20 W)
4—Support for power class 4 (30 W)
5—Support for power class 5 (40 W)
6—Support for power class 6 (50 W)
7—Support for power class 7 (70 W)

ER/ES Support field 1604B is indicating the support for Extended Range and Extended Signaling.

Bits 0-2 are coding the Extended Range (ER) supports as follows:
0b000—standard range
0b001—extended range support with PMA-1 support
0b010—extended range without PMA-1 support extended range
All other values RFU

Bits 3-4 code the Extended Signaling (ES) support as follows:
0b00—standard signaling
0b01—Uni-directional extended signaling support
0b10—Bi-directional extended signaling support
0b11—Continuous bi-directional extended signaling support

The SS&HCI support field 1606B includes indication for power receiver coil support for Host Control Interface (HCI) as bit 7. The received signal strength (as percentage) is provided on the lower 7 bits (bit 6-0). Further, the length of field is optionally 3 bytes.

Referring to FIG. 16C, illustrating a power transmitter coil Advance Capabilities Reporting (TACR) message structure 1600C operable in bi-directional message communication. The message structure 1600C may include message ID field 1602C, Length field 1604C, Capabilities field 1606C and CRC16 field 1608C.

It is noted that an AC power transmitter coil may be transmitting an Advanced Capabilities Reporting (TACR) message during the identification period as the first message when polled by a power receiver coil.

Where appropriate, the Message ID byte field 1602C may be set to 0x01 for the TACR message and the Length field 1604C, 1 byte long, may define the number of bytes that follow, optionally excluding the CRC16 bytes. Further, the Capabilities field 1606A, may have a variable length as may be indicated by the Length field. The Capabilities field 1606C is further shown in the structure detailed in FIG. 16D. The TACR message is terminated with CRC16 field of 2 bytes, optionally with 0x1201 generator Polynomial.

Referring to FIG. 16D, illustrating the Capabilities field structure 1606C of a power transmitter coil Advance Capabilities Reporting (TACR) message structure. The Capabilities field structure 1606C may include Power Level Supported field 1602D, ER/ES (Extended Range and Extended Signaling) Support field 1604D and ID Validation field 1606D.

The Power Level Supported field 1602D indicates the power classes the EP power transmitter coil may support. The possible bits of this field may be coded as follows:
0—Support for power class 0 (baseline 5 W)
1—Support for power class 1 (10 W)
2—Support for power class 2 (15 W)
3—Support for power class 3 (20 W)
4—Support for power class 4 (30 W)
5—Support for power class 5 (40 W)
6—Support for power class 6 (50 W)
7—Support for power class 7 (70 W)

ER/ES Support field 1604D is indicating the support for Extended Range and Extended Signaling.

Bits 0-2 are coding the Extended Range (ER) supports as follows:
0b000 standard range
0b001—extended range support with PMA-1 support
0b010—extended range without PMA-1 support extended range
All other values RFU

Bits 3-4 code the Extended Signaling (ES) support as follows:
0b00—Standard signaling
0b01—Uni-directional extended signaling support
0b10—Bi-directional extended signaling support
0b11—Continuous bi-directional extended signaling support

The RXID Validation support field 1606D includes indication for RXID verification by the power transmitter coil. Bit 7 may be set if RXID is verified and may be cleared if the power transmitter coil bypasses RXID verification. All other bits are RFU and should be set to 0. Optionally, the RXID validation support field is 3 bytes long.

### Extended Power Support:

It is noted that an Advanced Capabilities (AC) power receiver coil (AC) is operable to supporting operation with power levels higher than the standard 5 W.

As used herein, the term “EP” refers to Extended Power (EP) power receiver coil, used to identify such a power receiver coil.

Where appropriate, reference made to power classes may be determined by the following: power class 0 may support the 5 W baseline 5 W; power class 1 may support up to 10 W; power class 2 may support up to 15 W; power class 3 may support up to 20 W; power class 4 may support up to 30 W; power class 5 may support up to 40 W; power class 6 may support up to 50 W; and power class 7 may support up to 70 W.

Where appropriate, An EP may advertise support for any combination of power classes.

Where appropriate, an EP supporting a specific power class is further supporting the power classes lower than that power class, unless the combination of and a device does not include a battery, EP is powering the device directly and the device is not operable within the limits of lower power classes.

Where appropriate, an EP operating with the exceptions described hereinabove, advertising power support for higher power classes but not including support for all lower power classes, may be able to engage with all power transmitter coil devices supporting power classes up to it maximal power class while executing the full protocol negotiation of digital ping and identification phases. Further, indicating lack of support for lower power classes may signify that it may not move to power transfer phase when is not supporting the higher power class operation.

Where appropriate, an EP may be operable to supporting bi-directional extended signaling and may further support continuous bi-directional extended singling.

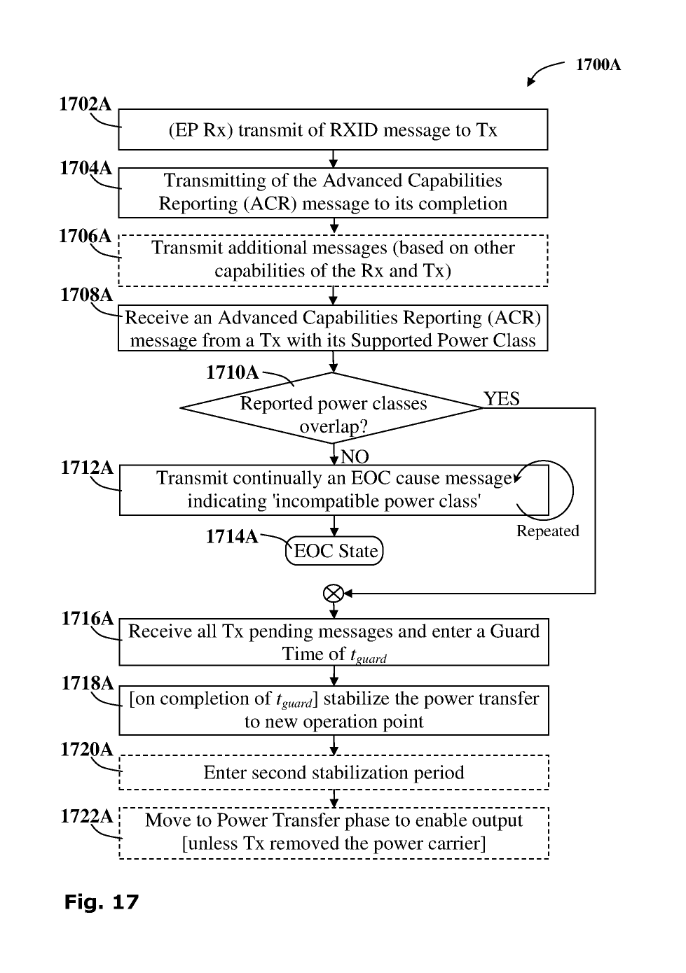

Reference is now made to flowchart of FIG. 17 representing selected actions illustrating possible extended power transmission communication 1700A initiated by a power receiver coil, providing bi-directional and possibly continuous extended signaling support. The extended power transmission communication 1700A may include the steps of: a power receiver coil transmitting an RXID message to power transmitter coilTx—step 1702A; once the transmission of the ID message is completed, then transmitting an Advanced Capabilities Reporting (ACR) message to its completion—step 1704A; optionally, transmitting additional messages (based on other capabilities of the power receiver coil and power transmitter coil); and receiving an Advanced Capabilities Reporting (ACR) message from the associated power transmitter coil with including its supported Power Classes.

If reported power classes do not overlap with the EP power classes—step 1708A, then transmitting continually an EOC cause message with 0x1F code indicating ‘incompatible power class’ and indefinite sleep followed by an EOC signal timer—step 1710A and moving into an EOC state—step 1712A. otherwise, if EP has not in EOC state—step 1714A, receiving all power transmitter coil pending messages, entering into guard time of t_{guard} (as detailed in table of FIG. 18)—step 1716A, at which the power receiver may be transmitting continually NoCh signals, allowing the adopting to operate in the agreed power class (the highest supported power class matching of the power receiver coil and the power transmitter coil). Where appropriate, adopting of the operation point may include a change in frequency, amplitude or duty cycle of power carrier; stabilizing the power transfer to new operation point—step 1718A, optionally by transmitting PMA_Inc, PMA NoCh and PMA_Dec signals, stopping once reaching the new operation point; optionally, entering into a second stabilization procedure—step 1720A, requiring completion of stabilization within t_{stab} time period (as detailed in table of FIG. 18) from end of Guard time; and moving to power transfer phase to enable power transferring—step 1722A, unless the power transmitter coil has removed its power carrier.

Reference is now made to table of FIG. 18, showing a timing table 1800A of possible power receiver coil extended signaling timing values. The timing table 1800A provides table columns of a parameter 1802A, associated symbol 1804A, minimum time value 1806A, target value 1808A, maximum time value 1810A and measuring units 1812A.

Optionally, the time gap parameter between the start bit of a power receiver coil transmitted byte to the next start bit while in the process of transmitting a message, associated with the symbol tₛₜ₂ₛₜ is having a maximum value of 20 milliseconds.

Optionally, the time gap parameter between a message start to next message start, associated with the symbol t_{msggap is} having a minimum value of 100 milliseconds.

Optionally, the default time gap parameter between MS_Polls, associated with the symbol t_{defaultpoll is} having a minimum value of 250 milliseconds and limited by a maximum value of 1000 milliseconds.

Optionally, the time gap parameter between MS_Polls while in the process of receiving a message from a power transmitter coil, associated with the symbol t_{msgpoll} is having a maximum value of 20 milliseconds.

Optionally, the total duration parameter of initialization phase, associated with the symbol t_{initbi} is having a maximum value of 500 milliseconds.

Optionally, the guard time from end of transmission to power class switch, associated with the symbol t_{guard} is having a minimum value of 20 milliseconds and limited by a maximum value of 25 milliseconds.

Optionally, stabilization time after power class switch, associated with the symbol t_{stab} is having a maximum value of 100 milliseconds.

### Extended EOC Report:

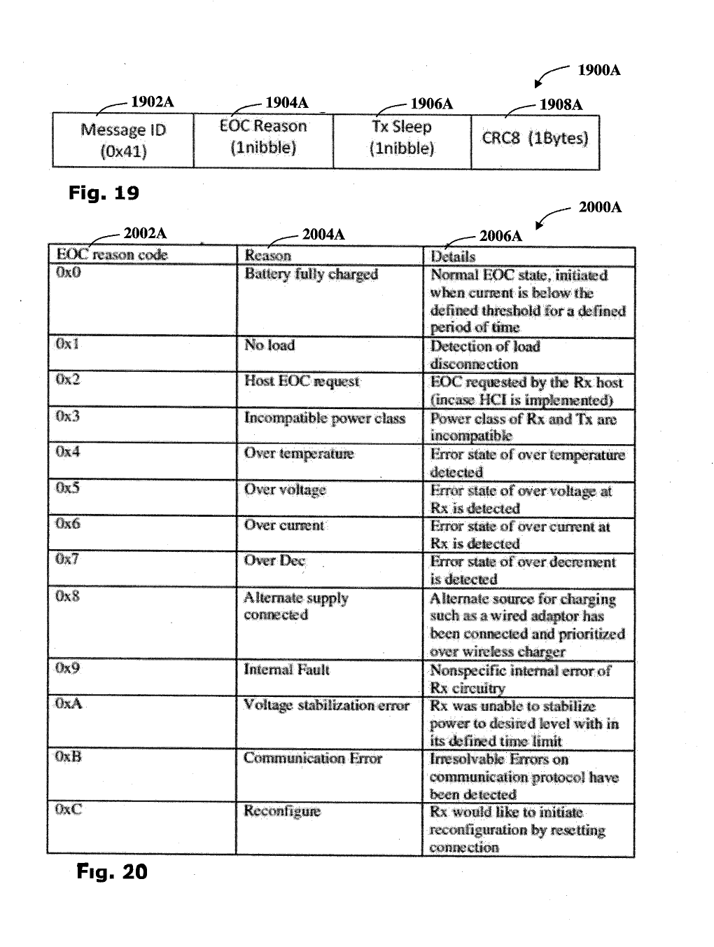

Reference is now made to FIG. 19, illustrating a power receiver coil extended EOC report message structure 1900A. The message structure 1900A may include message ID field 1902A, EOC reason field 1904A of 1 nibble long, power transmitter coil sleep field 1906A of 1 nibble long and CRC8 field 1908A of 1 byte long.

It is noted that a power receiver coil supporting any of the extended signaling capabilities is configured to supporting the transmission of EOC reason and sleep timer. Further, an Extended Signaling power receiver coil (ES) may further be configured transmitting an Extended EOC report message before transmitting EOC signals to a power transmitter coil. The ES power receiver coil is operable to continue periodically transmitting the Extended EOC report interleaved with the EOC signals until removing of the power carrier by the power transmitter coil.

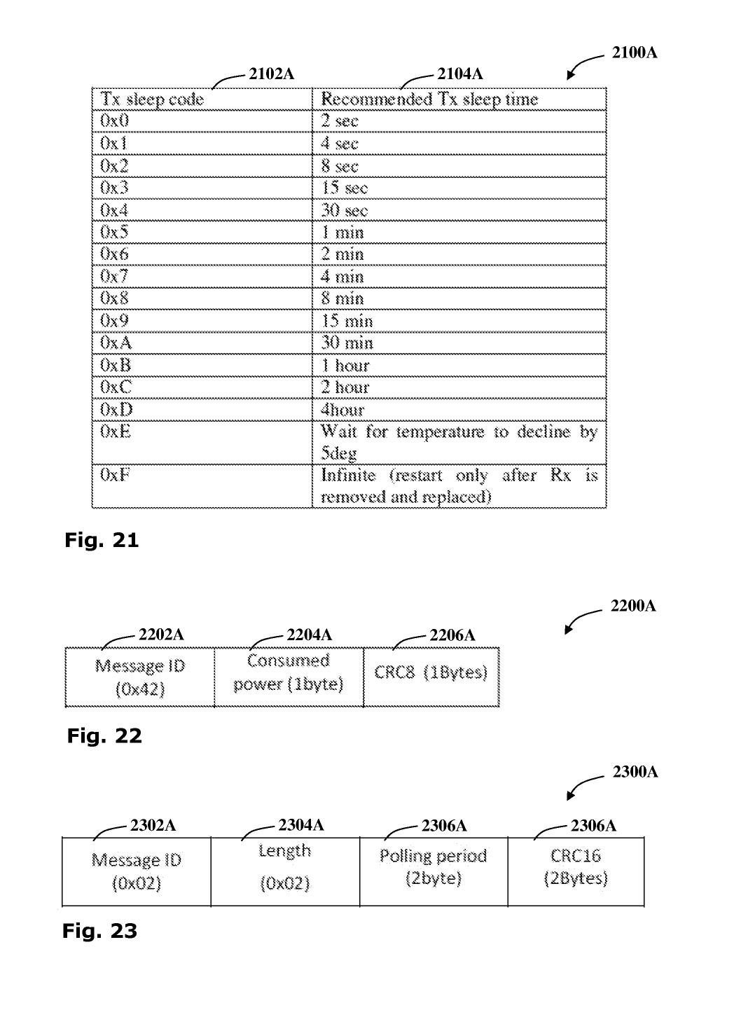

It is further noted that EOC reason is detailed in FIG. 20 and power transmitter coil sleep codes and recommended power transmitter coil sleep time are detailed in FIG. 21.

Referring to table of FIG. 20, showing EOC reasoning parameters providing reasons to the power receiver coil EOC request 2000A. The EOC reasoning table 2000A provides table columns of EOC reason code 2002A, Reason 2004A and details 2006A.

Where appropriate, for EOC reason code 0x0 reason is “Battery fully charged” and stated details are: Normal EOC state, initiated when current is below the defined threshold for a defined period of time; for EOC reason code 0x1 reason is “No load” and stated details are: Detection of load disconnection; for EOC reason code 0x2 reason is “Host EOC request” and stated details are: EOC requested by the power receiver coil host (in case HCI is implemented); for EOC reason code 0x3 reason is “Incompatible power class” and stated details are: Power class of a power receiver coil and a power transmitter coil are incompatible; for EOC reason code 0x4 reason is “Over temperature” and stated details are: Error state of over temperature detected; for EOC reason code 0x5 reason is “Over voltage” and stated details are: Error state of over voltage at is detected; for EOC reason code 0x6 reason is “Over current” and stated details are: Error state of over current at is detected; for EOC reason code 0x7 reason is “Over Dec” and stated details are: Error state of over decrement is detected; for EOC reason code 0x8 reason is “Alternate supply connected” and stated details are: Alternate source for charging such as a wired adaptor has been connected and prioritized over wireless charger; for EOC reason code 0x9 reason is “Internal Fault” and stated details are: Nonspecific internal error of power receiver coil circuitry; for EOC reason code 0xA reason is “Voltage stabilization error” and stated details are: was unable to stabilize power to desired level with in its defined time limit; for EOC reason code 0xB reason is “Communication Error” and stated details are: Irresolvable Errors on communication protocol have been detected; and for EOC reason code 0xC reason is “Reconfigure” and stated details are: would like to initiate reconfiguration by resetting connection.

Referring to table of FIG. 21, showing power transmitter coil sleep time values after current EOC 2100A. The sleep time table 2100A provides table columns of a power transmitter coil sleep code 2102A and recommended power transmitter coil sleep time 2104A.

Where appropriate, for sleep time code of 0x0 the recommended sleep time is 2 seconds; for sleep time code of 0x1 the recommended sleep time is 4 seconds; for sleep time code of 0x2 the recommended sleep time is 8 seconds; for sleep time code of 0x3 the recommended sleep time is 15 seconds; for sleep time code of 0x4 the recommended sleep time is 30 seconds; for sleep time code of 0x5 the recommended sleep time is 1 minute; for sleep time code of 0x6 the recommended sleep time is 2 minutes; for sleep time code of 0x7 the recommended sleep time is 4 minutes; for sleep time code of 0x8 the recommended sleep time is 8 minutes; for sleep time code of 0x9 the recommended sleep time is 15 minutes; for sleep time code of 0xA the recommended sleep time is 30 minutes; for sleep time code of 0xB the recommended sleep time is 1 hour; for sleep time code of 0xC the recommended sleep time is 2 hours; for sleep time code of 0xD the recommended sleep time is 4 hours; for sleep time code of 0xE the recommended sleep time is waiting for the temperature to decline by 5 degrees; and for sleep time code of 0xF the recommended sleep time is infinite, restarting only is being removed.

### Consumed Power Report:

Reference is now made to FIG. 22, illustrating a power receiver coil consumed power report message format 2200A. The message structure 2200A may include message ID field 2202A, Consumed power field 2204A of 1 byte long, and CRC8 field 2206A of 1 byte long.

It is noted that a power receiver coil supporting the extended range is operable transmitting consumed power report message as described herein. Other AC power receiver coil may also be configured to transmit such messages.

Where appropriate, the power receiver coil may be transmitting the consumed power report message every 30 seconds. Optionally, when there is a change in consumed power, deviating by more than +−20% compared to last report of consumed power, the power receiver coil may transmit updated consumed power report within 100 milliseconds from said change.

It is further noted that the consumed power field provides the power receiver coil consumed power data. This field is indicating the power percentage currently consumed out of pMax, where pMax is the maximal power of the currently used power class, as determined by the negotiation between power receiver coil and the power transmitter coil.

### Polling Period Configuration:

Reference is now made to FIG. 23, illustrating a power receiver coil polling period configuration (PPC) format 2300A. The message structure 2300A may include message ID field 2302A, Length field 2304A, polling period field 2306A of 2 bytes long and CRC16 field 2308A of 2 bytes long.

It is noted that a power transmitter coil supporting continuous bi-directional signaling may send a polling period configuration (PPC) message to a power receiver coil, setting the polling period.

The power receiver coil is configured to use a default of t_{defaultpoll} if not instructed otherwise by a power transmitter coil.

Referring again to FIG. 2, as noted above, where the transmission frequency is selected from the non-resonant region 8 above the resonant frequency of the system the output power of the secondary inductor may be regulated by increasing or decreasing the driving frequency by incremental amounts. According to one embodiment in which the transmission frequency is around 10 megahertz the incremental frequency steps δf may be selected from within a permissible range of 277 kilohertz to 357 kilohertz or so.

In one system the driver 1230 (FIG. 10) of the inductive power outlet may include a microcontroller unit operable to calculate the incremental frequency value fₒₚ₊₁−fₒₚ according to the formula:

$${f}_{op + 1} - {f}_{op} = \frac{{F}_{sys}}{dividervalue} - \frac{{F}_{sys}}{dividervalue - 1}$$

where F_{sys} is the transmission frequency of the driver, and the divider value is an integer value. Where required, different incremental values may be used for increasing and decreasing the voltage or power.

As noted, two power increase signals P-UP and P-DUP may request different incremental power increases. Accordingly the second power increase signal P-DUP may be used to step up power by larger increments, say twice the size of the standard increments. This may be useful for example where the initial voltage is particularly low.

In one embodiment, a transmission circuit 1122 (FIG. 10) may be used to produce a modulated peak pulse having a characteristic frequency selected from 500 hertz, 1 kilohertz, 8 kilohertz or the like. Variously, the inductive power receiver may select an ID signal such that predetermined transmission parameters may be selected for operating the inductive power outlet.

Additionally or alternatively, the transmission circuit 1122 (FIG. 10A) may be used to send digitally encoded data from the inductive power receiver 1300 to the inductive power transmitter 1200 via the inductive couple formed between the secondary inductor 1320 and the primary inductor 1220. Accordingly, the transmission circuit 1122 may be operable to generate a data transfer signal which may be used to send a digital communication.

Such digital communications may carry information relating to various factors such as operational data, supplementary data, identification data or the like. For example, operation data may include load characteristics, load identity, desired operating parameters, actual operating parameters or target operating parameters, such as induced voltage, induced current, required current, operating temperature, charge level, or such like. Supplementary data may include location data, synchronization of data, media files say, streamed media or the like.

Where appropriate, such digital communications may be used to provide additional power transfer management. For example, the digital communications may be used to communicate inter alia data relating to:
the resonant frequency of the system,
the selected range of operational frequencies,
the sizes of increment values of frequency or power by which the driver changes the power level when a P-UP signal, P-DOWN signal, P-DUP signal or the like is received,
load or receiver specific maximum power levels,
limits above which the inductive power transmitter should not transmit power,
power limiting for safety,
etc. . . .

It is particularly noted that the digital communication may be used to pass identification data between the inductive power receiver and the inductive power outlet. Identification data may include, for example, a device specific identity code, a user specific identity code, a receiver specific identity code or the like. Such identification codes may be used to pair a specific inductive outlet to a specific inductive receiver. It is noted that identification codes may be of particular utility in commercial systems where the identity of the user or receiver may be used to determine the permissions of that receiver to draw power from that outlet, to determine billing procedure for that power drawing action, to monitor the behavior of a particular user or receiver or the like. Still further uses for the data communication will occur to those skilled in the art such as those described in the applicants copending applications, U.S. Ser. Nos. 61/682,604 and 61/584,268, which are incorporated herein by reference in their entirety.

It is further noted that identification of the receiver may be used to determine user specific actions such as adjusting local environment. For example in a vehicle based system a inductive transmitter may use identification data received from an inductive power receiver to adjust the mirror, seat orientation, seat temperature, air conditioning, radio selections and the like to suit the personal preferences of the user. In another example, in a household environment the inductive transmitter may use identification data to cancel alarms, adjust the ambience, lighting, media preferences or the like to suit the user.

Furthermore, identification data may be used for billing purposes or may be used to determine personalized advertising targeted to the user.

Digital communications may be transmitted using the signal transfer system of the disclosure. It will be appreciated that digital communications may be constructed from multiple bits of information each of which may have a logic state 0 or a logic state 1.

The signal transfer system described herein may assign logic state peak pulses having differing characteristic frequencies to represent logic state 0 and logic state 1 and therewith to construct digital data. By way of example a logic state peak pulse may be assigned a characteristic frequency such as 2 kilohertz, 4 kilohertz, 5 kilohertz, 6 kilohertz, 10 kilohertz, 50 kilohertz or the like.

Optionally, a dedicated characteristic frequency peak pulse may be reserved for a logic state peak pulse. Alternatively, where required, a logic state peak pulse may share a characteristic frequency with one or more instruction signals.

It will be appreciated that communications, or messages, may be constructed from multiple bits. Strings of bits may represent bytes of information. Where appropriate, a byte may be characterized as a string of 10 bits: a BitST, Bit0, Bit1, Bit2, Bit3, Bit4, Bit5, Bit6, Bit7 and BitSP. The initial bit BitST may be a START bit used to indicate that the following string of eight bits represent a byte and BitSP may be a STOP bit used to indicate that the byte has terminated. According to a particular example BitST may set to logic state 0 to indicate initiation of a byte of data and BitSP may be set to logic state 1 to indicate the byte's termination.

The processor 1129 (FIG. 10A) associated with the peak detector 1128 of the inductive power outlet 1200, may be operable to interpret peak pulses of various characteristic frequencies differently depending upon the timing of the transmission and the operational phase during which it is transmitted.

For example a peak pulse having a certain characteristic frequency which is used as an instruction signal during power transmission, such as described above, may be used as a logic state pulse signal otherwise. Accordingly, in a non-limiting example, during an initial identification phase, a peak pulse having the characteristic frequency of an ID signal may be used to represent logic state 0 and a peak pulse having the characteristic frequency of the P-SAME, say, signal may be used to represent logic state 1. Whereas during transmission phase P-SAME may be used to instruct the driver to continue to drive the primary inductor.

It is further noted that during transmission, one logical state may be represented by an unambiguous characteristic frequency and the other logical state may be represented by any one of a set of other characteristic frequencies.

For example, logic state 0 may be represented by its own characteristic frequency MsgBIT, say 6 kilohertz. By contrast, logic state 1 may not have its own unique characteristic frequency. Instead, any of the other characteristic frequencies may be interpreted as representing logic state 1 by the processor 1129 (FIG. 10A) associated with the peak detector 1128 of the inductive power outlet 1200.

It is noted that, where multiple characteristic frequencies are all interpreted as the same logical state, the selection of the characteristic frequencies used may convey another level of information concurrently with the digital message. Thus, for example, during transmission, a digital message may be communicated using the MsgBIT frequency to represent logic state 0 while selection of the characteristic frequency for logic state 1 may be determined by the transmission requirement of the system at that instant. Accordingly, in the example:
if the power received by the inductive receiver is below a required level, the power increase signal P-UP may be used to represent logic state 1, such that the driver also increases the power level by an incremental value,
if the power received by the inductive receiver is above a required level, the power increase signal P-DOWN may be used to represent logic state 1, such that the driver also decreases the power level by an incremental value,
if the power received by the inductive receiver is within a required range, the power increase signal P-SAME may be used to represent logic state 1, such that the driver continue to drive the primary inductor with the same power level, and
if the load requires no more power, the termination signal END-SIG may be used to represent logic state 1, such that the driver ceases to drive the primary inductor and the inductive power outlet reverts to standby mode.

Accordingly, it is a particular feature of the present disclosure that digital communications may be transferred from the inductive receiver to the inductive outlet concurrently with power transmission regulation signals.

It is also noted that the digital communication may be used to provide a digital ping. Optionally, a digital ping phase may be used to identify that the receiver is valid for example. In order to engage with a possible receiver, a digital ping is generated. This digital ping may have a pre-defined structure regarding the frequencies and timing that should be used. If sufficient power is delivered to the receiver, it will respond by modulating the power signal according to the communication protocol. Where the transmitter received a valid signal from the receiver, it may continue to an identification phase without removing the power signal or a power transfer phase.

Optionally, inductive power receivers may have characteristic identification codes MACID which may be communicated in an RXID signal, accordingly, the receiver may be operable to identify itself to the inductive power outlet by sending the identification code MACID in the RXID signal.

According to one example protocol, where the receiver responds to the digital ping, the receiver may transmit a characteristic frequency peak pulse, say the P-SAME signal. The receiver may be operable to transmit such a signal within a milisecond after entering the ping phase and may continue transmitting this signal for an identification period t_{ID} before continuing to an identification phase. Optionally, entry to the digital ping phase on the receiver may be considered as the point where the bridge voltage of the Receiver reaches an initial rectified voltage Vₛₜₐᵣₜ required to bring the communication and control unit to an active state.

Where appropriate, the RXID message structure may comprise a string of bytes such as described herein. The byte string may comprise a preamble byte, a message ID byte, the MACID, which may itself comprise a string of six bytes, and a two byte cyclic redundancy check (CRC). Optionally, in a particular embodiment, the Preamble byte is fixed to 0x00 and the Message ID byte is set to 0xAA. It will be appreciated that other messages may be defined as suit requirements. Optionally, where required, a Certification-Version byte may be included possibly between the message ID byte and the MACID field.

According to a particular embodiment, the receiver may use the following flow of operation: On the completion of the Digital Ping phase, prior to enabling charging to the device, the receiver may transmit a “RXID message”, to make sure it is a fully compliant device. A guard-time of 20 milliseconds is provided, during which the transmitter calculates the CRC of the RXID message and the receiver transmits P-SAME signals. Once the guard time is over, the receiver may enter a power transfer phase.

The inductive power outlet may receive the RXID message and calculate the CRC, while maintaining the power level stable. If the CRC is valid, the inductive power transmitter will move to power transfer phase. If the CRC was not valid, the inductive power transmitter will remove the power carrier and transition to the standby phase. It may then restart the Digital Ping phase with the receiver and repeat the identifications attempt.

The wireless charging system can be in one of the following phases:
Standby
Digital Ping
Identification
Power Transfer
End of Charge (EOC)

As mentioned herein, the transition from one phase to another may be the result of the communication between the receiver and the transmitter. The transition between Standby phase and Digital Ping phase includes the use of a detection mechanism that will be described herein below.

During the Standby phase, the transmitter monitors its surface to detect a possible receiver's placement. There are a few methods that can be used to detect a possible placement of a receiver, e.g., monitoring the change in the magnetic field, monitoring the change in capacitance, and monitoring changes in the overall inductance of the system. In addition, two or more of the above may be used in combination, mutatis mutandis.

The system will continue to the Digital Ping phase if a possible placement of a receiver was detected using one of the above methods.

The purpose of the Digital Ping phase is to engage with a possible receiver and to identify that it is a valid receiver (and not a foreign object that creates, e.g., a parasitic current). To engage with a possible receiver, a Digital Ping is generated having a predefined structure regarding the frequencies and timing that should be used. If sufficient power is delivered to the receiver, it will respond by modulating the power signal according to the communication protocol used by the wireless charging system. If the transmitter receives a valid signal from the receiver, it will continue to the Identification phase, without removing the power signal. In case identification is not supported by the transmitter, it will continue to the Power Transfer phase.

If an EOC request was received from the receiver, the system will continue to the End of Charge phase. If no response was detected, the system will return to the Standby phase.

Support for the Identification phase on transmitters is optional.

Each receiver will have a unique identification string, and upon completion of Digital Ping, it is required to identify itself to the transmitter to verify it is a fully compliant device. As part of this identification the receiver sends its identification string.

Transmitters that support the Identification phase validate the identification string. If the identification string is validated successfully, the system will continue to the Power Transfer phase. If the validation failed, or was not completed in time, the system phase would change to Standby.

In this phase, the transmitter will provide power to the receiver, by controlling the primary cell current according to the control data received from the receiver. In addition, the transmitter verifies that no violation of proper operation boundaries and safety limits occurred (e.g. foreign object detection).

If EOC request was received from the receiver, or the temperature exceeds the maximum defined value, the system removes the power signal and continues to the End of Charge phase. In any other case of violation (as specified above), the system will remove the power signal and returns to Standby phase. A new charging cycle will begin by simply removing the receiver from the surface and placing it again.

The transmitter shall enter the EOC phase if an End of Charge (EOC) request is received from the receiver (charging completed) or temperature readings in the transmitter exceeded the predefined range.

If the reason for entering this phase was an EOC request, the transmitter should remove the power carrier and wait for a period of tₛₗₑₑₚ (the typical tₛₗₑₑₚ depends of the type of transmitter, as defined below). After tₛₗₑₑₚ expires, the transmitter will continue to the Digital Ping phase to engage again with the receiver that is placed on the surface. The transmitter also monitors the surface for a possible removal of the receiver during the sleep time of the EOC phase. If a removal of the receiver was detected, the transmitter will return to the Standby phase.

If the reason for entering this phase was high temperature readings in the transmitter, the transmitter monitors the transmitter's temperature. If the temperature drops to a valid value, the transmitter will continue to the Digital Ping phase. The transmitter also monitors the surface for a possible removal of the receiver during this time. If a removal of the receiver is detected, the transmitter should return to the Standby phase.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least 10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

1-22. (canceled)

23. A method for use in a wireless power transfer system configured to control wireless power transfer in an improved manner, said wireless power transfer system comprising:
at least one wireless power outlet and at least one electrical device associated with a wireless power receiver, said wireless power receiver being in bi-directional communication with said wireless power outlet,
wherein said wireless power receiver comprises a receiver processor operable to execute power control instructions and configured to communicate periodically at least one polling request to said at least one wireless power outlet for at least one communication message, said method comprising:
obtaining a receiver polling period, said receiver polling period determining a time interval that the receiver processor is polling said at least one wireless power outlet;
receiving said at least one communication message from said at least one wireless power outlet;
processing said at least one communication message; and
sending at least one communication response to said at least one wireless power outlet.

24. The method of claim 23, wherein said step of receiving at least one communication message further comprises the steps of:
sending said at least one polling request to said at least one wireless power outlet, said at least one polling request being configured to indicate to said at least one wireless power outlet to transmit said at least one communication message; and
receiving said at least one communication message.

25. The method of claim 23, wherein said step of processing said at least one communication message further comprises the steps of:
decoding said at least one communication message;
computing a CRC of said at least one communication message;
if said CRC is valid, then sending an acknowledged message; and
if said CRC is erroneous, then sending an error message.

26. The method of claim 25, wherein said sending an error message comprises sending a redacted CRC message of the last received correct communication message.

27. The method of claim 25, wherein said sending an acknowledged message comprises sending a redacted CRC message of said at least one communication message.

28. The method of claim 23, wherein said step of obtaining a receiver polling period comprises returning a default receiver polling period value to determine said receiver polling period.

29. The method of claim 23, wherein said step of obtaining a receiver polling period comprises the steps of:
obtaining a recommended polling period value from said wireless power transmitter coil; and
returning said recommended receiver polling period value to determine said receiver polling period.

30. The method of claim 24, wherein said at least one communication message comprises a transmitter advanced capabilities report (TACR) message.

31. The method of claim 30, wherein said transmitter advanced capabilities report (TACR) message comprises a message ID, data pertaining to a message length, data pertaining to a transmitter capabilities structure and a two byte cyclic redundancy check (CRC16).

32. The method of claim 31, wherein said message ID is set to 0x01 indicating it is representing said transmitter advanced capabilities report message.

33. The method of claim 31, wherein said transmitter capabilities structure comprises data pertaining to a power level supported, data pertaining to an extended range support, data pertaining to an extended signaling support, data pertaining to RXID validation.

34. The method of claim 33, wherein said RXID validation is indicating that RXID verification is executed by said at least one wireless power outlet.

35. The method of claim 24, wherein said at least one communication message comprises a polling period configuration (PPC) message, said polling period configuration message comprising data overriding the receiver default polling period associated with said wireless power receiver.

36. The method of claim 35, wherein said polling period configuration (PPC) message comprises a message ID, data pertaining to a message length, data pertaining to a polling period and a two byte cyclic redundancy check (CRC16).

37-45. (canceled)

46. The method of claim 33, wherein said power level supported is selected from a group consisting of a power class of 5 W, a power class of 10 W, a power class of 15 W, a power class of 20 W, a power class of 30 W, a power class of 40 W, a power class of 50 W, and a power class of 70 W.

47. The method of claim 33, wherein said extended range is selected from a group consisting of standard range and extended.

48. The method of claim 33, wherein said extended signaling is selected from a group consisting of standard signaling, uni-directional extended signaling, bi-directional extended signaling, and bi-directional continuous signaling.

49. The method of claim 24, said step of sending at least one polling request further comprises the step of:
if a received communication message from said wireless power outlet is valid, then continue sending additional polling requests until full message is completely received.

50. The method of claim 23, wherein said step of sending at least one communication response further comprises the steps of:
disabling polling request transmissions;
sending said at least one communication response; and
enabling polling request transmissions.

51. The method of claim 23, wherein said receiver polling period is set as a default time interval of at least one second.
